(19) United States
(12) Patent Application Publication
(10) Pub. No.: US 2023/0345581 A1
(43) Pub. Date: Oct. 26, 2023

(54) Method and Apparatus for Releasing RRC Connection

(71) Applicant: Huawei Technologies Co., Ltd., Shenzhen (CN)

(72) Inventors: Mingzhen Zhang, Shenzhen (CN); Kai Yuan, Shenzhen (CN); Lianyi Zhao, Shenzhen (CN)

(21) Appl. No.: 18/044,934

(22) PCT Filed: Sep. 10, 2021
(86) PCT No.: PCT/CN2021/117557

§ 371 Date: Mar. 10, 2023

(30) Foreign Application Priority Data
Sep. 11, 2020 (CN) 202010956218.X

(51) Int. Cl. H04W 76/36; H04W 60/00

(52) U.S. Cl. CPC H04W 76/36; H04W 60/00

(57) ABSTRACT

In a method for releasing a Radio Resource Control (RRC), connection a first RRC connection between a terminal and a network device is used for data transmission between the terminal and the network device. The method terminal releases a local resource of the first RRC connection and establishes a second RRC connection to the network device when releasing the first RRC connection. The terminal sends a registration message to the network device through the second RRC connection, where the registration message registers with the network device and indicates that the terminal has no service requirement on the second RRC connection. The terminal receives a second RRC connection release request from the network device, and releases a local resource of the second RRC connection in response to the second RRC connection release request.

This application claims priority to Chinese Patent Application No. 202010956218.X, filed with the China National Intellectual Property Administration on Sep. 11, 2020 and entitled “METHOD AND APPARATUS FOR RELEASING RRC CONNECTION”, which is incorporated herein by reference in its entirety.

### TECHNICAL FIELD

This application relates to the communication field, and in particular, to a method and an apparatus for releasing an RRC connection.

### BACKGROUND

In a long term evolution (Long Term Evolution, LTE) system, from a perspective of radio resource control (Radio Resource Control, RRC), an RRC status of a terminal includes an RRC_IDLE (RRC_IDLE) state and an RRC_CONNECTED (RRC_CONNECTED) state. When the terminal has no service, the terminal is in the RRC_IDLE state. When the terminal has a service, the terminal needs to switch to the RRC_CONNECTED state to perform data transmission. Compared with that in the RRC_CONNECTED state, the terminal in the RRC_IDLE state reduces more power consumption.

In a 5G new radio (new radio, NR) system, an RRC_INACTIVE (RRC_INACTIVE) state is introduced to the terminal based on the RRC_IDLE state and the RRC_CONNECTED state. Air interface behavior of the terminal in the RRC_INACTIVE state is basically consistent with that of the terminal in the RRC_IDLE state. Therefore, in the RRC_INACTIVE state and the RRC_IDLE state, the terminal has a same energy saving effect that is, the terminal has less power consumption than the terminal in the RRC_CONNECTED state.

In conventional technologies of the LTE system and the 5G system, a base station may send an RRC connection release message to a terminal, to initiate an RRC connection release process. In this way, after receiving the RRC connection release message, the terminal may release an RRC connection, and switch from an RRC_CONNECTED state to an RRC_IDLE state or an RRC_INACTIVE state. Specifically, the base station configures an inactivity timer for the terminal, and generally sets duration to 10s or 20s. If service transmission is detected by the base station, the base station restarts the timer. If no service transmission is detected by the base station, the timer expires. When the inactivity timer expires, the base station is triggered to send an RRC connection release message to the terminal. After receiving the RRC connection release message, the terminal enters an RRC connection release procedure.

However, in some LTE and 5G networks, many base stations do not configure the foregoing inactivity timer. As a result, the terminal is always in the RRC_CONNECTED state and cannot enter the release procedure. This results in very high power consumption of the terminal.

### SUMMARY

Embodiments of this application provide a method and an apparatus for releasing a radio resource control RRC connection, so that a terminal can actively trigger release of the RRC connection, to reduce power consumption of the terminal.

According to a first aspect, this application provides a method for releasing a radio resource control RRC connection, applied to a system including a terminal and a network device. There is a first RRC connection between the terminal and the network device, and the first RRC connection is used for data transmission between the terminal and the network device. The method includes:

The terminal releases a local resource of the first RRC connection and establishes a second RRC connection to the network device when determining to release the first RRC connection.

The terminal sends a registration message to the network device through the second RRC connection, where the registration message is used to register with the network device and indicate that the terminal has no service requirement on the second RRC connection.

The network device releases the local resource of the first RRC connection and a local resource of the second RRC connection and sends a first RRC connection release message and a second RRC connection release message to the terminal after receiving the registration message sent by the terminal.

By using this method, the terminal can actively trigger the network device to release a radio air interface resource. To be specific, after determining to release the RRC connection, the terminal actively releases a local RRC connection resource, sends the registration message to the network device to complete RRC status synchronization between the terminal and the network device, and finally completes release of the RRC connection. This helps reduce power consumption of the terminal.

In an implementation, the method further includes: The terminal receives the second RRC connection release message, and releases the local resource of the second RRC connection in response to the second RRC connection release message.

In an implementation, releasing a local resource of the first RRC connection and establishing a second RRC connection to the network device includes:
releasing the local resource of the first RRC connection, and generating the registration message sent to the network device; and
establishing the second RRC connection to the network device.

In an implementation, that the network device releases the local resource of the first RRC connection and a local resource of the second RRC connection and sends a first RRC connection release message and a second RRC connection release message to the terminal after receiving the registration message sent by the terminal includes:

After receiving the registration message sent by the terminal, the network device detects that the first RRC connection is a residual resource, releases the local resource of the first RRC connection, and sends the first RRC connection release message to the terminal.

The network device determines, based on the registration message, that the terminal has no service requirement on the second RRC connection and a connection management status maintained by the network device for the terminal is an idle state, releases the local resource of the second RRC connection, and sends the second RRC connection release message to the terminal.

In an implementation, that the terminal determines to release the first RRC connection includes: The terminal determines, when detecting that no service data is transmitted within first duration, to release the first RRC connection, or the terminal determines, in a machine learning prediction manner, to release the first RRC connection. In this way, the terminal determines that service data transmission ends, so that a moment at which service transmission of the terminal ends can be accurately determined as soon as possible, to release the RRC connection as soon as possible. This reduces power consumption of the terminal.

In an implementation, the first duration is duration that is set by the terminal based on a service scenario type. In this way, power consumption of the terminal can be further reduced by setting the first duration based on the service scenario type.

In an implementation, the service scenario type includes at least one of the following: screen on and Wi-Fi not connected, screen off and Wi-Fi not connected, Wi-Fi connected, or a sleep mode.

In an implementation, the first duration is duration that is set by the terminal based on applications of different service data types. In this way, requirements of different applications on a data transmission delay are considered, and the first duration is set based on different requirements, so that power consumption of the terminal can be reduced, and user experience can be prevented from being affected by releasing the RRC connection in advance by the terminal.

In an implementation, when the terminal determines to release the first RRC connection, the terminal does not receive the first RRC connection release message sent by the network device.

In an implementation, in a new radio NR standalone networking system, the registration message is a registration request message; and in a long term evolution LTE system, the registration message is a tracking area update request message.

In an implementation, that the terminal releases a local resource of the first RRC connection and establishes a second RRC connection to the network device when determining to release the first RRC connection includes:

When the terminal determines to release the first RRC connection, an RRC layer of the terminal performs local RRC resource release, sends a resource release indication message to a layer 1 and a layer 2 of the terminal, and sends a second message to a non-access stratum of the terminal, where the second message triggers the non-access stratum of the terminal to generate the registration message.

The terminal establishes the second RRC connection to the network device.

In an implementation, in a new radio NR non-standalone networking system, the first RRC connection is a first RRC connection of LTE, and the first RRC connection of LTE is used for data transmission of the terminal on an LTE side. There is an RRC connection of NR between the terminal and the network device, and the RRC connection of NR is used for data transmission of the terminal on an NR side. The registration message is a tracking area update request message, and the second RRC connection is a second RRC connection of LTE.

In a possible implementation, in the new radio NR non-independent networking system, that the terminal releases a local resource of the first RRC connection and establishes a second RRC connection to the network device when determining to release the first RRC connection includes:

The terminal determines that the first RRC connection of LTE is to be released and that no RRC connection of NR exists, releases a local resource of the first RRC connection of LTE, and establishes the second RRC connection of LTE to the network device.

In an implementation, before the terminal determines that the first RRC connection of LTE is to be released and that no RRC connection of NR exists, the method includes:

The terminal sends a third message to the network device when determining to release the RRC connection of NR, where the third message is used to indicate the network device to release the RRC connection of NR.

The network device receives the third message, releases, in response to the third message, a local resource that is on a network device side and that is of the RRC connection of NR, and sends a fourth message to the terminal.

The terminal receives the fourth message, and releases, in response to the fourth message, a local resource that is on a terminal side and that is of the RRC connection of NR. In this method, the terminal can release the RRC connection step by step, that is, first release the RRC connection of NR, and then release an RRC connection of LTE, to finally reduce power consumption of the terminal.

In an implementation, releasing a local resource of the first RRC connection of LTE, and establishing the second RRC connection of LTE to the network device includes:

An RRC layer on the LTE side of the terminal performs local RRC resource release, sends a resource release indication message to a layer 1 and a layer 2 on the LTE side of the terminal, and sends a second message to a non-access stratum of the terminal, where the second message triggers the non-access stratum of the terminal to generate the registration message.

The terminal establishes the second RRC connection of LTE to the network device. In an implementation, that the terminal releases a local resource of the first RRC connection and establishes a second RRC connection to the network device when determining to release the first RRC connection includes:

When determining to release the first RRC connection of LTE and the RRC connection of NR, the terminal releases a local resource of the first RRC connection of LTE and a local resource of the RRC connection of NR, and establishes the second RRC connection of LTE to the network device.

In an implementation, that the network device releases the local resource of the first RRC connection and a local resource of the second RRC connection and sends a first RRC connection release message and a second RRC connection release message to the terminal after receiving the registration message sent by the terminal includes:

After receiving the registration message sent by the terminal, the network device releases the local resource of the first RRC connection of LTE, the local resource of the RRC connection of NR, and a local resource of the second RRC connection of LTE, and sends a first RRC connection release message of LTE and a second RRC connection release message of LTE to the terminal.

In this method, when determining to release both the RRC connection of LTE and the RRC connection of NR, the terminal can release both the RRC connection of LTE and the RRC connection of NR together, to finally reduce power consumption of the terminal.

Another aspect of this application provides a method for releasing an RRC connection by a terminal. A first RRC connection exists between the terminal and a network device, and the first RRC connection is used for data transmission between the terminal and the network device. The method includes:

The terminal releases a local resource of the first RRC connection and establishes a second RRC connection to the network device when determining to release the first RRC connection.

The terminal sends a registration message to the network device through the second RRC connection, where the registration message is used to register with the network device and indicate that the terminal has no service requirement on the second RRC connection.

By using this method, the terminal can actively trigger the network device to release a radio air interface resource. To be specific, after determining to release the RRC connection, the terminal actively releases a local RRC connection resource, sends the registration message to the network device to complete RRC status synchronization between the terminal and the network device, and finally completes release of the RRC connection. This helps reduce power consumption of the terminal.

In an implementation, the method further includes: The terminal receives a second RRC connection release message sent by the network device. The second RRC connection release message is generated by the network device based on the received registration message. The terminal releases a local resource of the second RRC connection in response to the second RRC connection release message.

In an implementation, releasing a local resource of the first RRC connection and establishing a second RRC connection to the network device includes: releasing the local resource of the first RRC connection, and generating the registration message sent to the network device; and establishing the second RRC connection to the network device.

In an implementation, that the terminal determines to release the first RRC connection includes: The terminal determines, when detecting that no service data is transmitted within first duration, to release the first RRC connection, or the terminal determines, in a machine learning prediction manner, to release the first RRC connection. In this way, the terminal determines that service data transmission ends, so that a moment at which service transmission of the terminal ends can be accurately determined as soon as possible, to release the RRC connection as soon as possible. This reduces power consumption of the terminal.

In an implementation, the first duration is duration that is set by the terminal based on a service scenario type. In this way, power consumption of the terminal can be further reduced by setting the first duration based on the service scenario type.

In an implementation, the service scenario type includes at least one of the following: screen on and Wi-Fi not connected, screen off and Wi-Fi not connected, Wi-Fi connected, or a sleep mode.

In an implementation, the first duration is duration that is set by the terminal based on applications of different service types. In this way, requirements of different applications on a data transmission delay are considered, and the first duration is set based on different requirements, so that power consumption of the terminal can be reduced, and user experience can be prevented from being affected by releasing the RRC connection in advance by the terminal.

In an implementation, when the terminal determines to release the first RRC connection, the terminal does not receive a first RRC connection release message sent by the network device.

In an implementation, in a new radio NR standalone networking system, the registration message is a registration request message; and in a long term evolution LTE system, the registration message is a tracking area update request message.

In an implementation, that the terminal releases a local resource of the first RRC connection and establishes a second RRC connection to the network device when determining to release the first RRC connection includes:

When the terminal determines to release the first RRC connection, an RRC layer of the terminal performs local RRC resource release, sends a resource release indication message to a layer 1 and a layer 2 of the terminal, and sends a second message to a non-access stratum of the terminal, where the second message triggers the non-access stratum of the terminal to generate the registration message.

The terminal establishes the second RRC connection to the network device.

In an implementation, that the terminal releases a local resource of the first RRC connection and establishes a second RRC connection to the network device when determining to release the first RRC connection includes:

The terminal determines that a first RRC connection of LTE is to be released and that no RRC connection of NR exists, releases a local resource of the first RRC connection of LTE, and establishes a second RRC connection of LTE to the network device.

In an implementation, before the terminal determines that the first RRC connection of LTE is to be released and that no RRC connection of NR exists, the method further includes:

The terminal sends a third message to the network device when determining to release the RRC connection of NR, where the third message is used to indicate the network device to release the RRC connection of NR.

The terminal receives a fourth message sent by the network device, and releases a local resource of the RRC connection of NR in response to the fourth message.

In this method, the terminal can release the RRC connection step by step, that is, first releases the RRC connection of NR, and then releases the RRC connection of LTE, to finally reduce power consumption of the terminal.

In an implementation, releasing a local resource of the first RRC connection of LTE, and establishing a second RRC connection to the network device includes:

An RRC layer on an LTE side of the terminal performs local RRC resource release, sends a resource release indication message to a layer 1 and a layer 2 on the LTE side of the terminal, and sends a second message to a non-access stratum of the terminal, where the second message triggers the non-access stratum of the terminal to generate the registration message.

The terminal establishes the second RRC connection of LTE to the network device.

In an implementation, that the terminal releases a local resource of the first RRC connection and establishes a second RRC connection to the network device w % ben determining to release the first RRC connection includes: When determining to release a first RRC connection of LTE and an RRC connection of NR, the terminal releases a local resource of the first RRC connection of LTE and a local resource of the RRC connection of NR, and establishes a second RRC connection of LTE to the network device.

In this method, when determining to release both the RRC connection of LTE and the RRC connection of NR, the terminal can release both the RRC connection of LTE and the RRC connection of NR together, to finally reduce power consumption of the terminal.

Another aspect of this application provides an apparatus. The apparatus includes a processor. The processor is coupled to a memory, reads instructions in the memory, and enables, according to the instructions, the apparatus to perform the method according to the first aspect.

In an implementation, the apparatus is a terminal or a chip.

Another aspect of this application provides a computer program product including instructions. When the computer program product runs on a terminal, the terminal is enabled to perform the method according to the first aspect.

Another aspect of this application provides a computer-readable storage medium, including instructions. When the instructions are run on a terminal, the terminal is enabled to perform the method according to the first aspect.

Another aspect of this application provides an apparatus for reducing power consumption. The apparatus for reducing power consumption is disposed in a terminal, and includes: an identification unit, configured to identify a service scenario type of the terminal, and further configured to identify an application type of service data; a determining unit, configured to determine whether service data transmission of the terminal ends; a signaling sending unit, configured to send a NAS message to a network device when it is detected that the terminal does not transmit service data within first duration; a signaling receiving unit, configured to receive an RRC connection release message sent by the network device; and a release unit, configured to: when it is detected that service data is not transmitted within the first duration, release, by the terminal, an RRC connection, and further configured to receive the RRC connection release message sent by the network device, to release the RRC connection.

### BRIEF DESCRIPTION OF DRAWINGS

FIG. 1A is a schematic diagram of a radio communication architecture according to an embodiment of this application;

FIG. 1B shows a radio access protocol system according to an embodiment of this application;

FIG. 2 is a schematic diagram of a structure of a mobile communication system according to an embodiment of this application:

FIG. 3A is a method for releasing an RRC connection in a related technology according to the conventional technology;

FIG. 3B is a procedure of a method for releasing an RRC connection according to an embodiment of this application;

FIG. 4A is a general flowchart of RRC connection release in standalone networking of an NR system according to an embodiment of this application;

FIG. 4B is a general procedure of releasing an RRC connection in an LTE system according to an embodiment of this application;

FIG. 4C is a schematic diagram of structures of three modes in NSA networking of an option 3 series according to an embodiment of this application;

FIG. 4D is a schematic diagram of a protocol stack in NSA networking of an option 3 series according to an embodiment of this application;

FIG. 4E(1) and FIG. 4E(2) show a procedure of releasing an RRC connection in NSA networking in an option 3x mode according to an embodiment of this application;

FIG. 4F(1) and FIG. 4F(2) show another procedure of releasing an RRC connection in NSA networking in an option 3x mode according to an embodiment of this application;

FIG. 5 is a flowchart in which a terminal sets first duration based on a service scenario type according to an embodiment of this application;

FIG. 6 is a flowchart in which a terminal sets first duration based on an application to which service data belongs according to an embodiment of this application;

FIG. 7A is a schematic diagram of user state transition in standalone networking of an NR system according to an embodiment of this application;

FIG. 7B(1) and FIG. 7B(2) are a flowchart of a principle of actively triggering RRC connection release by a terminal in standalone networking of an NR system according to an embodiment of this application;

FIG. 8A is a schematic diagram of user state transition in an LTE system according to an embodiment of this application;

FIG. 8B(1) and FIG. 8B(2) are a flowchart of a principle of actively triggering RRC connection release by a terminal in an LTE system according to an embodiment of this application:

FIG. 9 is a schematic diagram of overall steps of actively triggering RRC connection release by a terminal according to an embodiment of this application;

FIG. 10A is a procedure in which a terminal restores a normal service when a network device does not take effect in a solution in this embodiment of this application according to an embodiment of this application;

FIG. 10B is another procedure in which a terminal restores a normal service when a network device does not take effect in the solution in this embodiment of this application according to an embodiment of this application;

FIG. 11 is a block diagram of a structure of an apparatus for releasing an RRC connection according to an embodiment of this application; and

FIG. 12 is a schematic diagram of a structure of a terminal according to an embodiment of this application.

### DESCRIPTION OF EMBODIMENTS

To make the objectives, technical solutions, and advantages of the present invention clearer, the following further describes implementations of the present invention in detail with reference to the accompanying drawings.

In this specification, “a plurality of” refers to two or more than two. The term “and/or” describes an association relationship for describing associated objects and represents that three relationships may exist. For example, A and/or B may represent the following three cases: Only A exists, both A and B exist, and only B exists. The character “/” generally indicates an “or” relationship between associated objects.

For ease of understanding, the following explains a radio communication architecture, a radio access protocol system, and related terms in embodiments of the present invention.

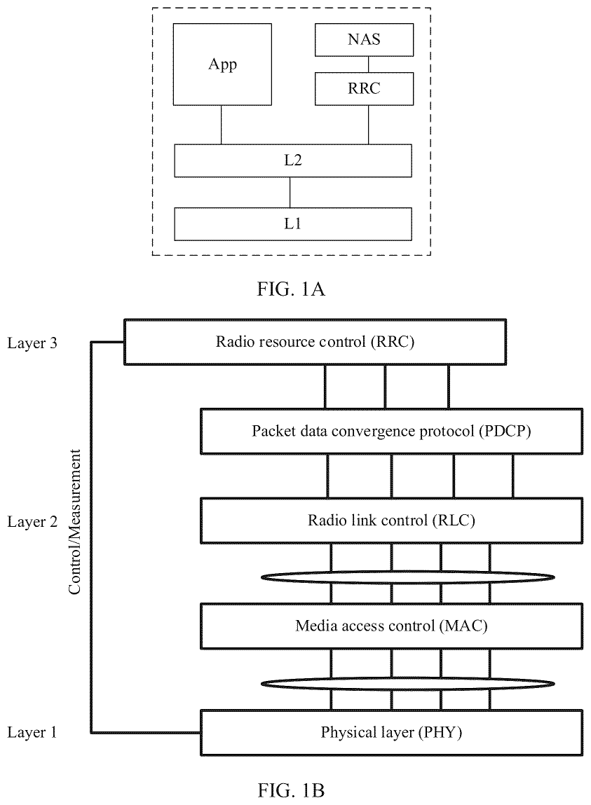

As shown in FIG. 1A, the radio communication architecture mainly includes an application (Application, APP) layer, a non-access stratum (Non-access stratum, NAS) layer, a radio resource control (Radio Resource Control, RRC) layer, a layer 2 (Layer 2, L2), and a layer 1 (Layer 1, L1). The application layer receives and sends user-plane data depending on services provided by the L2 and the L1. The NAS stratum and RRC layer receive and send control-plane signaling depending on the services provided by the L2 and the L1. A function of the application layer is deployed in an application processor of a terminal, and functions of the non-access stratum, the radio resource control layer, the layer 2, and the layer 1 are deployed in a baseband processor of the terminal.

As shown in FIG. 1B, a radio access protocol system (also referred to as a radio access layer) is divided into three layers. A layer 1 is a physical layer (PHY), a layer 2 includes a media access control (MAC) sublayer, a radio link control (RLC) sublayer, and a packet data convergence protocol (PDCP) sublayer, and a layer 3 is an RRC layer. The physical layer is a bottom layer of the radio access system. The physical layer uses a transmission channel as an interface to provide a service for an upper layer.

The RRC layer is an upper layer of a radio access protocol control plane and is mainly responsible for controlling the layer 1 and the layer 2 to complete air interface resource transmission, completing an RRC connection control function by using a service of a lower layer, and providing an information transmission service for the NAS stratum.

The PDCP sublayer belongs to the layer 2 of the radio access protocol system, and processes a radio resource management (RRC) message on the control plane and an Internet Protocol (IP) packet on a user plane. The PDCP sublayer provides functions such as packet encryption and decryption, integrity protection and verification, and packet header decompression.

The RLC sublayer belongs to the layer 2 of the radio access protocol system, and is located between the PDCP sublayer and the MAC sublayer. The RLC sublayer communicates with the PDCP sublayer by using a service access point (SAP) and communicates with the MAC sublayer through a logical channel. The RLC sublayer supports a transparent mode, an unacknowledged mode, and an acknowledged mode.

The NAS stratum is located at an upper layer of the radio access protocol system, that is, a protocol layer at which the terminal communicates with a core network device by using a radio access stratum (Access stratum, AS). A message of the NAS stratum is independent of a protocol structure of an AS stratum below to some extent.

An RRC-CONNECTED (RRC-CONNECTED) state is also referred to as a service state. After the terminal camps on a cell and completes a random access procedure (establishes an RRC connection), the terminal enters the RRC-CONNECTED state. If the terminal in the RRC-CONNECTED state does not perform data transmission with a base station for a long time, the base station sends a message to the terminal to release the RRC connection to the terminal. When the terminal is in the RRC-CONNECTED state, the terminal continuously listens to data on a control channel of the base station. As a result, the terminal is in a state of high power consumption.

After the terminal in the RRC-CONNECTED state receives an RRC release message sent by the base station, the terminal disconnects the RRC connection to the base station, and enters an RRC-IDLE (RRC-IDLE) state. Power consumption of the terminal in the RRC-IDLE state is very low. Therefore, power consumption of the terminal can be reduced by releasing the RRC connection of the terminal.

An RRC-INACTIVE (RRC-INACTIVE) state is a new RRC status introduced in an NR system to reduce power consumption of the terminal and a system delay. When the terminal is in the RRC-INACTIVE state, the RRC connection between the terminal and the base station is in a disconnected state, but the base station and a core network are in a connected state. In this way, a procedure of restoring the terminal to the RRC-CONNECTED state is simplified. A radio air interface behavior of the terminal in the RRC-INACTIVE state is consistent with that of the terminal in the RRC-IDLE state. Therefore, the RRC-INACTIVE state also helps reduce power consumption of the terminal.

An application processor (Application Processor, AP) is a processor that is configured to run an operating system and an application and that is in the terminal.

A baseband processor (Baseband Processor, BP) is also referred to as a baseband chip (modem). The application processor AP communicates with the baseband chip (modem) through a shared memory (shared memory). Optionally, the application processor AP and the baseband processor BP may be integrated into one processor.

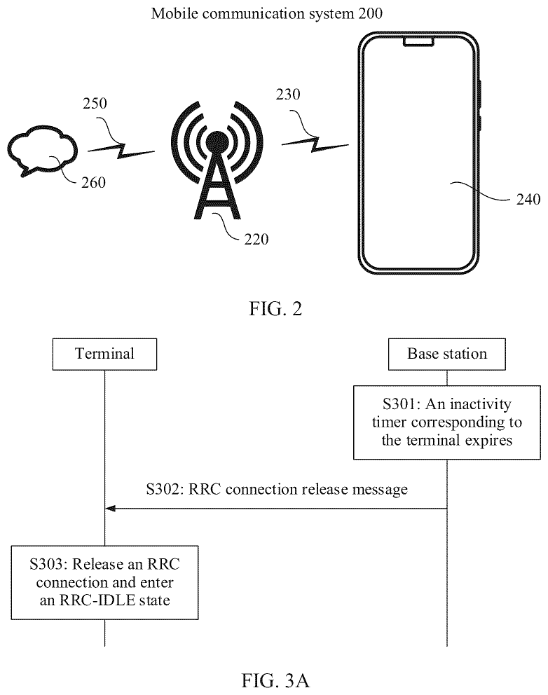

FIG. 2 is a schematic diagram of a structure of a mobile communication system 200 according to an embodiment of the present invention. The mobile communication system may be a long term evolution (Long Term Evolution, LTE) system, a fifth-generation mobile communication technology 5G new radio (new radio, NR) system, a machine to machine (Machine To Machine, M2M) system, or a future evolved sixth-generation communication system. The mobile communication system includes a base station 220, a terminal 240, and a core network device 260. The base station 220 and the core network device 260 may be collectively referred to as a network device.

The base station 220 may be configured to perform mutual conversion between a received radio frame and an IP packet, and may further coordinate attribute management on an air interface. For example, the base station 220 may be an evolved NodeB (evolved NodeB, eNB) in LTE, or a base station that has a centralized distributed architecture and that is used in a 5G system. The base station 220 may also be an access point (Access Point, AP), a transmission node (Trans Point, TRP), a central unit (Central Unit, CU), or another network entity, and may include some or all of functions of the foregoing network entities. In addition, the base station 220 further includes a relay station. The relay station is a transmission station that receives data and/or other information from an upstream station and sends data and/or other information to a downstream station. The relay station may also be a terminal that provides relay transmission for another terminal. The relay station may also be referred to as a repeater.

The mobile communication system 200 may be a heterogeneous system including different types of base stations (for example, a macro base station, a picocell base station, a femto base station, and a repeater). These different types of base stations may have different transmit power levels, different coverage areas, and different interference impact. For example, the macro base station may have a high transmit power level (for example, 20 watts), and the picocell station, the femto base station, and the repeater may have a low transmit power level (for example, 1 watt).

The base station 220 and the terminal 240 establish a radio connection through a radio air interface. The radio air interface may be a radio air interface based on an LTE standard, or the radio air interface is a radio air interface based on a 5G standard. For example, the radio air interface is NR, or the radio air interface may be a radio air interface based on a 5G-based technology standard of a more next-generation mobile communication network.

The terminal 240 may be a device that provides voice and/or data communication for a user. The terminal may communicate with one or more core network devices 260 through a radio access network (Radio Access Network, RAN) provided by the base station 220. The terminal 240 may be a mobile terminal, for example, a mobile phone or a computer that has a mobile terminal, for example, a portable, pocket-sized, handheld, computer built-in, or vehicle-mounted mobile apparatus.

Specifically, the base station 220 may be configured to communicate with the terminal 240 through a wireless interface 230 under control of a network device controller (not shown in FIG. 2). In some embodiments, the network device controller may be a part of the core network device 260, or may be integrated into the base station 220. The base station 220 may transmit information or user data to the core network device 260 through an interface 250 (for example, an S1 interface). The base station 220 and the base station 220 may also communicate with each other through an interface (for example, an X2 interface, which is not shown in FIG. 2).

It should be noted that the wireless communication system 200 shown in FIG. 2 is merely intended to more clearly describe the technical solutions in this application, but is not intended to limit this application. Persons of ordinary skill in the art may know that, as a network architecture evolves and a new service scenario emerges, the technical solutions provided in this application are also applicable to a similar technical problem.

In the LTE and NR systems, when a terminal has a service requirement, the terminal needs to initiate an RRC connection to enter the RRC_CONNECTED state. After service transmission is completed, to save power, the terminal receives an RRC connection release message sent by a base station and switches to the RRC_IDLE state or the RRC_INACTIVE state. The following solutions can be used to trigger the terminal to switch from the RRC_CONNECTED state to the RRC_IDLE or the RRC_INACTIVE state.

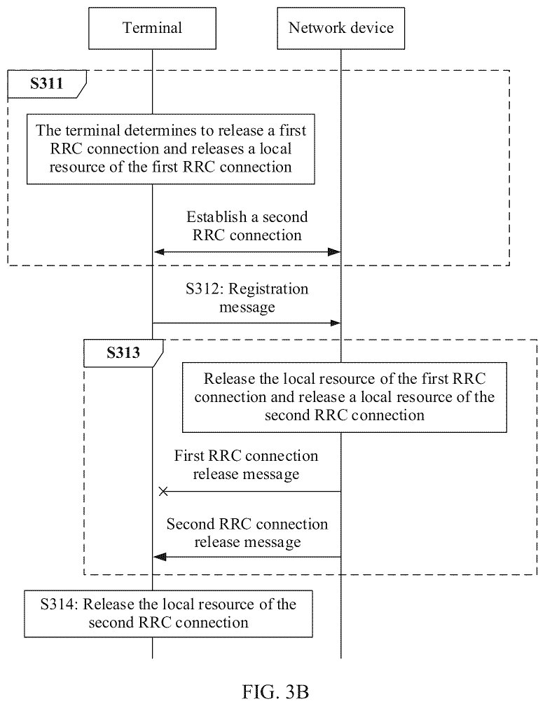

As shown in FIG. 3A, after a terminal establishes an RRC connection to a base station, the base station maintains an inactivity timer for the terminal. A name of the timer is inactivity timer, and the timer immediately starts to run after successful access of the terminal. If the base station detects that the terminal has service data transmission, the base station restarts the inactivity timer corresponding to the terminal. If the base station does not detect service data transmission of the terminal within duration of the inactivity timer, the inactivity timer corresponding to the terminal expires, and the base station sends an RRC connection release message to the terminal. Based on data obtained from an actual network, the duration of the inactivity timer is generally set to 10s to 20s. As a result, after service transmission ends, the terminal further needs to maintain the RRC_CONNECTED state for 10s to 20s. This causes unnecessary additional power consumption of the terminal. In addition, in an early stage of 5G development, many base stations do not configure the inactivity timer or there is another network problem. As a result, the terminal cannot receive the RRC connection release message, and unnecessary power consumption is caused to the terminal.

It can be learned that, in the conventional technology, the base station determines to release the RRC connection of the terminal by determining that service transmission of the terminal ends. In addition, even if the base station enables a function of the inactivity timer, the base station processes each terminal in a consistent manner, and does not consider different service scenarios of the terminals. For example, when the terminal is in a screen-off scenario, the terminal may receive a small amount of data after a long time interval, and data transmission duration may be less than 1s. However, the terminal still needs to wait for a period of time before receiving the RRC connection release message. This causes extra power consumption.

To resolve the foregoing existing technical problem, an embodiment of this application provides a method for reducing power consumption of a terminal. Specifically, the method is implemented by actively triggering RRC connection release by the terminal, and differentiated processing is performed on different service scenarios of the terminal, so that power consumption of the terminal can be reduced.

A procedure of a method for releasing an RRC connection provided in an embodiment of this application is shown in FIG. 3B. The method is applied to a system including a terminal and a network device. There is a first RRC connection between the terminal and the network device. The first RRC connection is used for data transmission between the terminal and the network device. The data includes service data and signaling data. The procedure includes the following steps.

S311. When the terminal determines to release the first RRC connection, the terminal releases a local resource of the first RRC connection, and establishes a second RRC connection to the network device. Specifically, the terminal determines, by detecting that no service data is transmitted within first duration, to release the first RRC connection, or the terminal determines, in a machine learning prediction manner, to release the first RRC connection.

S312. The terminal sends a registration message to the network device through the second RRC connection, where the registration message is used to register with the network device and indicate that the terminal has no service requirement on the second RRC connection. Specifically, in an NR system, the registration message is a registration request message; and in an LTE system, the registration message is a tracking area update request message.

S313. After receiving the registration message sent by the terminal, the network device releases the local resource of the first RRC connection and a local resource of the second RRC connection, and sends a first RRC connection release message and a second RRC connection release message to the terminal. Because the terminal releases the first RRC connection in advance, the terminal cannot receive the first RRC connection release message.

S314. The terminal receives the second RRC connection release message, and releases the local resource of the second RRC connection in response to the second RRC connection release message.

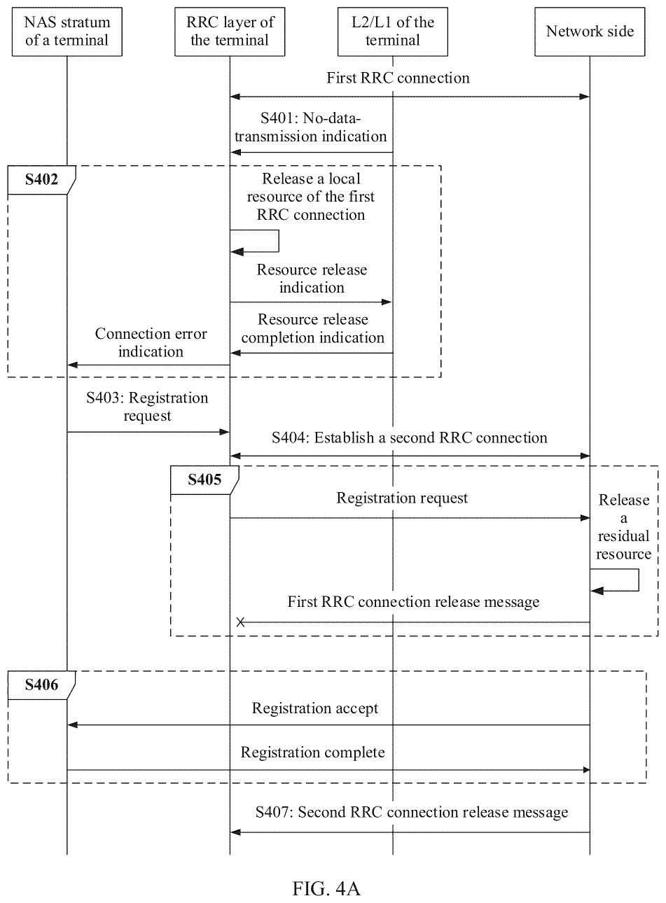

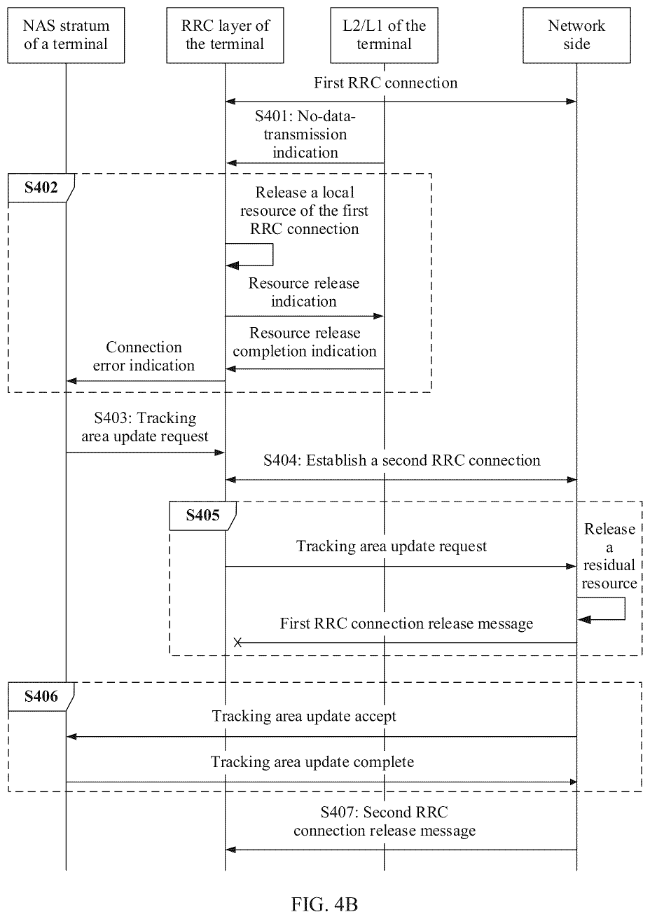

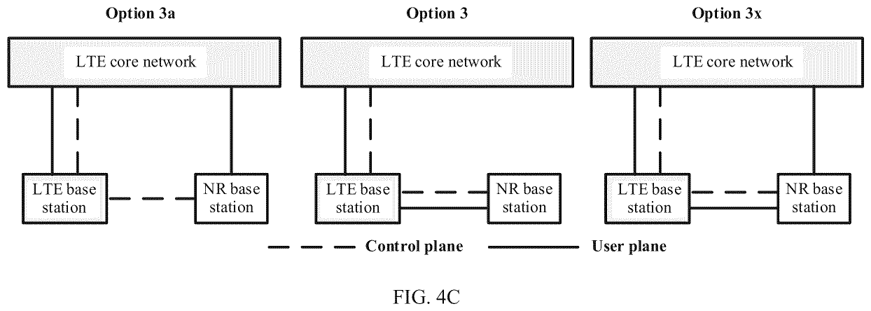

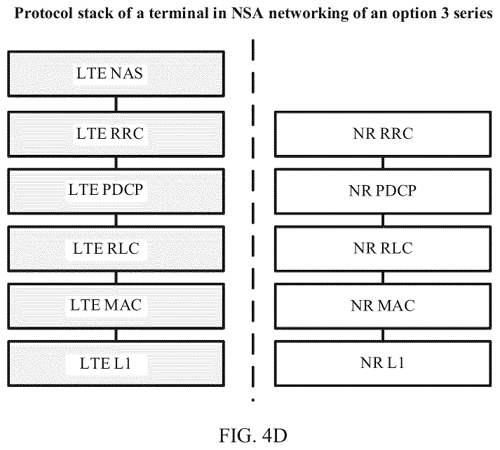

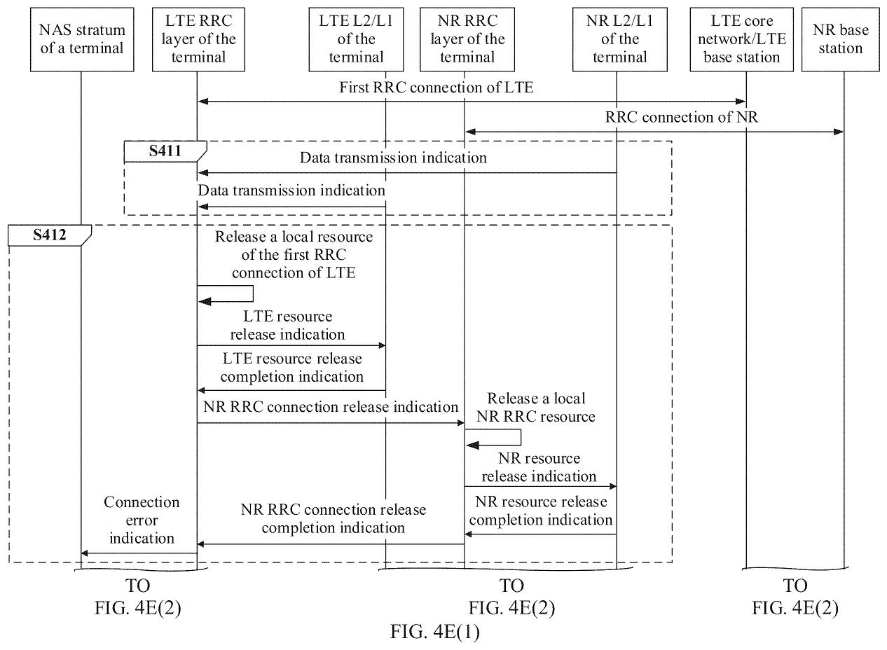

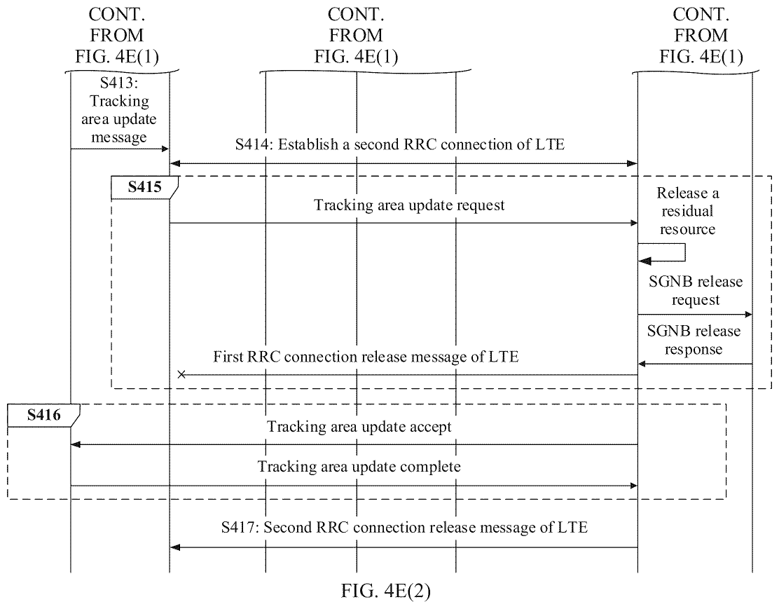

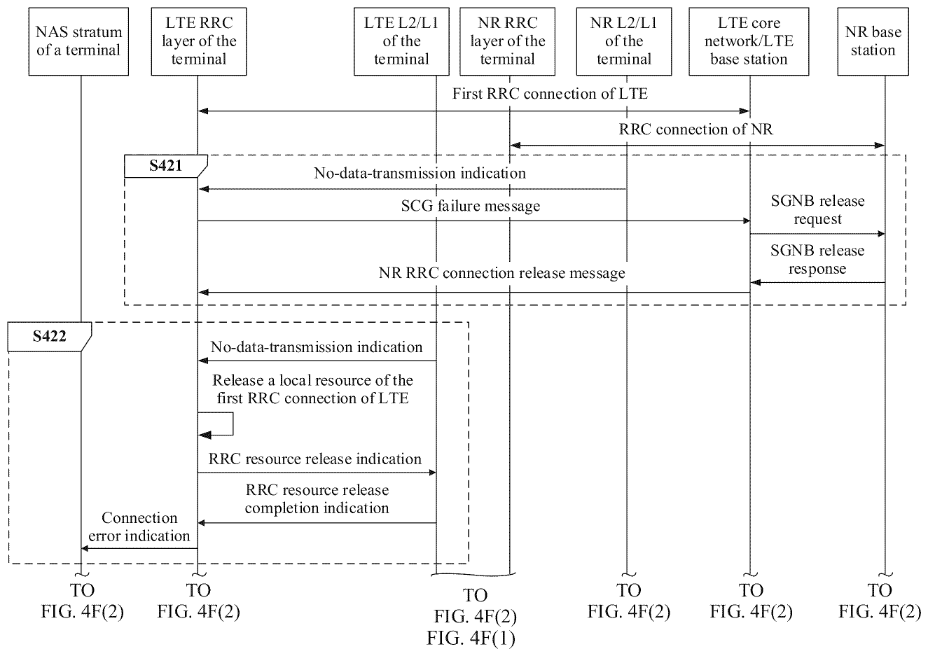

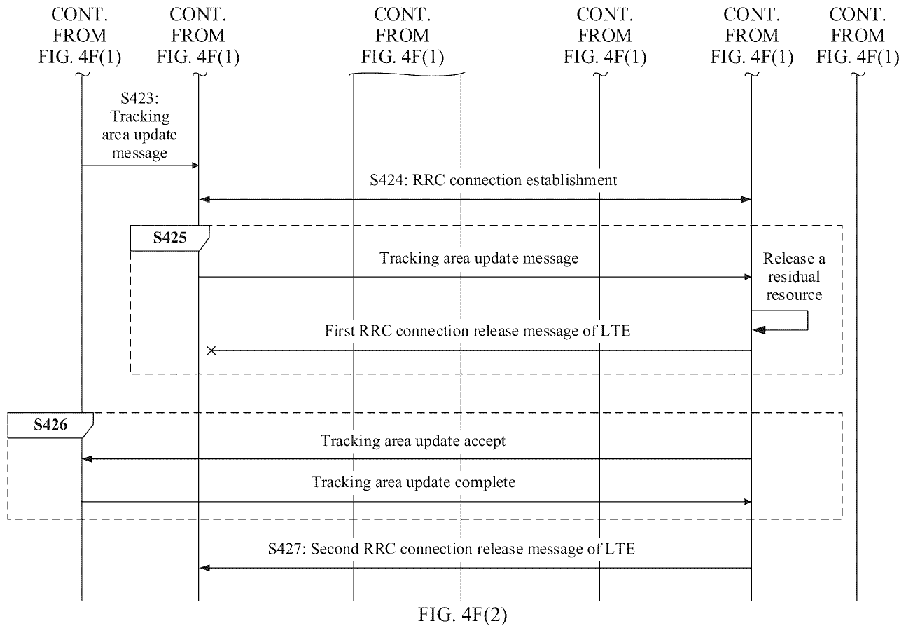

FIG. 4A shows a specific processing procedure corresponding to a standalone (Standalone, SA) networking scenario in an NR system, and FIG. 4B shows a specific processing procedure corresponding to an LTE system. Refer to FIG. 1A and FIG. 1B. There is a first RRC connection between a terminal and a network device, the first RRC connection is used for data transmission of the terminal, and the data includes service data and signaling data. A method for releasing an RRC connection provided in this embodiment of this application includes the following steps.

S401. When a PDCP sublayer of an L2 of the terminal does not detect service data transmission within specific duration, the PDCP sublayer sends a no-data-transmission indication to an RRC layer of the terminal.

Optionally, a no-data-transmission detection function may be implemented by using a transmission time interval (Transmission time interval, TTI, which is generally 1 ms in the LTE system, and generally 0.5 ms in the NR system) interrupt of the PDCP sublayer of the L2 of the terminal. Specifically, the PDCP sublayer of the terminal fixedly detects service data transmission once every N TTIs (namely, specific duration). If no service data transmission is detected, the PDCP sublayer sends a no-data-transmission indication message to the RRC layer of the terminal. When receiving the no-data-transmission indication message, the RRC layer of the terminal records a current timestamp, and determines, based on a difference between the current timestamp and a timestamp when the no-data-transmission indication message is received last time, whether the no-data-transmission indication message is continuously received, that is, determines whether a time difference between two adjacently received no-data-transmission indication messages is N TTIs. A specific time deviation needs to be considered in a determining process. After the RRC layer of the terminal continuously receives M times of no-data-transmission indication messages, it may be determined that the terminal does not transmit service data within the first duration. A value of M may be obtained through calculation based on the first duration. For example, the first duration is 20 s. In the LTE system, when a value of N is 5, and the TTI is 1 ms, the value of M is 4000 (=20 s/5/1 ms). In an implementation of the TTI interrupt, the RRC layer of the terminal determines that the terminal does not transmit the service data within the first duration, and the PDCP sublayer of the L2 of the terminal does not need to use the first duration.

Optionally, a no-data-transmission detection function may also be implemented by starting a no-data-transmission detection timer at the PDCP sublayer of the L2 of the terminal. First, the PDCP sublayer of the L2 of the terminal creates and starts a no-data-transmission detection timer based on the first duration (namely, specific duration). When the PDCP sublayer of the L2 of the terminal detects that there is data to be transmitted, the PDCP sublayer restarts the no-data-transmission detection timer. For example, the first duration may be set to 20 s. If the PDCP sublayer of the L2 of the terminal does not detect service data transmission within the duration of the no-data-transmission detection timer, the no-data-transmission detection timer expires, and the PDCP sublayer of the L2 of the terminal sends the no-data-transmission indication message to the RRC layer of the terminal. After the RRC layer of the terminal receives the no-data-transmission indication message, it may determine that the terminal does not transmit service data within the first duration. In an implementation of creating and starting the no-data-transmission detection timer at the PDCP sublayer of the L2 of the terminal, the PDCP sublayer of the L2 of the terminal uses the first duration to create the no-data-transmission detection timer, and the RRC layer of the terminal does not need to use the first duration.

S402. If the RRC layer of the terminal determines, based on the received no-data-transmission indication, that the terminal does not transmit the service data within the first duration, the RRC layer of the terminal releases a local resource of the first RRC connection, which includes: releasing a resource at the RRC layer of the terminal, and sending a resource release indication message to the L2 and the L1 of the terminal to release corresponding RRC resources. After the RRC layer of the terminal receives resource release completion indications of the L2 and the L1 of the terminal, the RRC layer of the terminal sends a second message, for example, a connection error indication message, to a NAS stratum of the terminal. In an optional implementation, when releasing the local resource of the first RRC connection, the RRC layer of the terminal may send the second message to the NAS stratum of the terminal. In another optional implementation, the RRC layer of the terminal may release the local resource of the first RRC connection after sending the second message to the NAS stratum of the terminal. It should be noted that, when releasing the local resource of the first RRC connection, the terminal does not receive a first RRC connection release message sent by the network device.

S403. After receiving the connection error indication message, the NAS stratum of the terminal sets, to an IDLE state, a NAS connection management status maintained by the terminal, and initiates a corresponding NAS procedure, that is, sends a registration message to the RRC layer of the terminal. In the NR system, after receiving the connection error indication message, the NAS stratum of the terminal sets a connection management (Connection Management, CM) status from a CM-CONNECTED state to a CM-IDLE state, and sends a registration request (Registration Request) message (namely, the registration message) to the RRC layer of the terminal, to send the registration request message to an air interface by using the RRC layer of the terminal. A Follow-on request field in the registration request message is set to 0. In the LTE system, after receiving the connection error indication message, the NAS stratum of the terminal sets an EPS (Evolved Packet System) connection management (EPS Connection Management, ECM) status from an ECM-CONNECTED state to an ECM-IDLE state, and sends a tracking area update request (Tracking Area Update Request) message (namely, the registration message) to the RRC layer of the terminal, to send the tracking area update request message to an air interface by using the RRC layer of the terminal. An Active Flag field in the tracking area update request message is set to 0.

S404. After receiving the registration message, the RRC layer of the terminal detects that the local resource of the first RRC connection is released, and triggers a procedure of establishing a second RRC connection. For the NR system, the registration message is a registration request message; for the LTE system, the registration message is a tracking area update request message. The RRC connection establishment procedure includes: The RRC layer of the terminal sends an RRC connection establishment request message to the network device. The network device sends an RRC establishment message to the RRC layer of the terminal after receiving the RRC connection establishment request message. The RRC layer of the terminal sends an RRC establishment completion message to the network device after receiving the RRC establishment message.

S405. After the second RRC connection is established, the RRC layer of the terminal sends the received registration message to the network device through the newly established second RRC connection. After receiving the registration message sent by the terminal, the network device detects that the first RRC connection is a residual resource, releases the local resource of the first RRC connection, and sends the first RRC connection release message to the terminal. Specifically, the network device includes a core network and a base station. The core network identifies, based on a new user identity allocated by the base station to the terminal, that a residual context of the terminal is not released, and sends a context release request message to the base station. After receiving the context release request message, the base station releases the residual resource on the base station side, and sends the first RRC connection release message to the RRC layer of the terminal through the first RRC connection, to release the first RRC connection. Because the terminal has released the local resource of the first RRC connection in advance, the terminal cannot receive the first RRC connection release message. Specifically, for the NR system, when the terminal initially registers with the network, a base station gNB (next generation NodeB) allocates a user identity RAN UE NGAP ID 1 to the terminal, and notifies an AMF (access and mobility management function) entity of the core network of the user identity RAN UE NGAP ID 1. When the terminal establishes the second RRC connection, the base station gNB allocates a new user identity RAN UE NGAP ID 2 to the terminal, and notifies the AMF entity of the core network of the new user identity RAN UE NGAP ID 2. If the AMF entity of the core network detects that the RAN UE NGAP ID 1 and the RAN UE NGAP ID 2 correspond to a same terminal, the AMF entity identifies that a residual context of the terminal is not released, and sends a context release request message to the base station gNB. After receiving the context release request message, the base station gNB releases a residual resource corresponding to the RAN UE NGAP ID 1 on the base station gNB side, and sends the first RRC connection release message to the terminal. For the LTE system, when the terminal initially attaches to a network, a base station eNB allocates a user identity eNB UE S1AP ID 1 to the terminal and notifies an MME (mobility management entity) of the core network of the user identity eNB UE S1AP ID 1. When the terminal establishes the second RRC connection, the base station eNB allocates a new user identity eNB UE S1AP ID 2 to the terminal and notifies the MME of the core network of the new user identity eNB UE S1AP ID 2. If the MME of the core network detects that the RAN UE NGAP ID 1 and the RAN UE NGAP ID 2 correspond to a same terminal, the MME identifies that a residual context of the terminal is not released, and sends a context release request message to the base station eNB. After receiving the context release request message, the base station eNB releases a residual resource corresponding to the RAN UE NGAP ID 1 on the base station eNB side, and sends the first RRC connection release message to the terminal.

S406. The terminal and the network device continue to complete the corresponding NAS procedure. In the NR system, the network device sends a registration accept (Registration Accept) message to the NAS stratum of the terminal. After receiving the registration accept message, the NAS stratum of the terminal sends a registration complete (Registration Complete) message to the network device. For the LTE system, the network device sends a tracking area update accept (Tracking Area Update Accept) message to the NAS stratum of the terminal. After receiving the tracking area update accept message, the NAS stratum of the terminal sends a tracking area update complete (Tracking Area Update Complete) message to the network device.

S407. After receiving a second RRC connection release message sent by the network device, the terminal releases the second RRC connection. Specifically, if the network device maintains the connection management status of the terminal as the IDLE state, and detects that the registration message indicates that the terminal has no service requirement on the second RRC connection, the network device sends the second RRC connection release message to the RRC layer of the terminal. The NAS procedure in Step S406 depends on the RRC connection. Therefore, the RRC connection can be released only after the corresponding NAS procedure is completed. For the NR system, the RAN UE NGAP ID 2 is a user identity newly allocated by the base station gNB to the terminal, and a user corresponding to the identity has not completed a registration procedure. Therefore, a connection management status maintained by the network device for the user corresponding to the RAN UE NGAP ID 2 is the CM-IDLE state. In addition, when detecting that the Follow-on request field in the registration message is 0, that is, the registration message indicates that the terminal has no service requirement on the second RRC connection, the network device sends the second RRC connection release message to the RRC layer of the terminal to release the newly established second RRC connection. For the LTE system, the eNB UE S1AP ID 2 is a user identity newly allocated by the base station eNB to the terminal, and a user corresponding to the user identity has not completed tracking area update. Therefore, a connection management status maintained by the network device for the user corresponding to the eNB UE S1AP ID 2 is the ECM-IDLE state. In addition, when detecting that the Active Flag field in the tracking area update request message is 0, that is, the tracking area update request message indicates that the terminal has no service requirement on the second RRC connection, the network device sends the second RRC connection release message to the RRC layer of the terminal to release the newly established second RRC connection.

In an optional implementation, the RRC layer of the terminal sets a second RRC connection release flag after sending the registration message to the network device in Step S405. After the terminal completes the corresponding NAS procedure in Step S406, that is, after the terminal sends the registration complete message or the tracking area update complete message to the network device, the terminal immediately releases a local resource of the second RRC connection based on the second RRC connection release flag, instead of releasing the local resource of the second RRC connection after receiving the second RRC connection release message sent by the network device.

In addition to the standalone (Standalone, SA) networking scenario shown in FIG. 4A, there is a non-standalone (Non-Standalone, NSA) networking scenario in the NR system. There are many NSA networking modes, including an option 3 series, an option 4 series, and an option 7 series. The option 3 series is the most widely deployed NSA networking mode. As shown in FIG. 4C, the option 3 series includes three modes: an option 3, an option 3a, and an option 3x. In the figure, dashed lines represent connections on the control plane, and solid lines represent connections on the user plane. It can be learned from FIG. 4C that NSA networking of the option 3 series is a dual-connectivity architecture, and a terminal in a connected state may use radio resources of both an LTE base station and an NR base station. In the option 3, the LTE core network is used for all NSA networking. The control plane is anchored on the LTE network. That is, the control-plane signaling is transmitted through the LTE system. The NR system enhances a user-plane data transmission capability by adding a secondary cell group (Secondary Cell Group, SCG) bearer.

In the three networking modes of the option 3 series, both the LTE base station and the NR base station have control-plane connections, and the NR base station may send control-plane signaling to the terminal through the connection by using the LTE base station. In an option 3a networking mode, both the LTE base station and the NR base station have user-plane connections to the LTE core network. When an SCG bearer is added, the NR base station can establish an independent bearer for data transmission. In an option 3 networking mode, there is a user-plane connection between the LTE base station and the LTE core network, and the NR base station establishes a user-plane connection to the LTE base station through an X2 interface. A PDCP entity of the SCG bearer added by the base station for the terminal is established on the LTE base station side. After receiving data from the LTE core network, the PDCP entity may forward or distribute the data to an RLC entity of the NR base station through the X2 interface. In an option 3x networking mode, both the LTE base station and the NR base station have user-plane connections to the LTE core network. The NR base station establishes a user-plane connection to the LTE base station through the X2 interface. A PDCP entity of the SCG bearer added by the base station for the terminal is established on the NR base station side. After receiving data from the LTE core network, the PDCP entity may forward or distribute the data to an RLC entity of the LTE base station through an X2 interface.

In the dual-connectivity architecture of the option 3 series, if the terminal supports an LTE connection and an NR connection on an air interface, functions of both LTE and NR radio access stratums need to be implemented. As shown in FIG. 4D, an RRC layer, an L2 (including a PDCP sublayer, an RLC sublayer, and a MAC sublayer), and an L1 of a terminal each have two versions: LTE and NR.

An NSA networking mode of the option 3x is used as an example. There is a first RRC connection of LTE between a terminal and a network device, the first RRC connection of LTE is used for data transmission of the terminal on the LTE side, and the data includes service data and signaling data. In addition, there is an RRC connection of NR between the terminal and the network device, the RRC connection of NR is used for data transmission of the terminal on the NR side, and the data includes service data and signaling data. The RRC connection of NR is an RRC connection established by the terminal to establish an SCG bearer, and a PDCP entity of the SCG bearer is established on the NR side of the terminal. In this embodiment of this application, there are two manners in which the terminal triggers RRC connection release in the NSA networking mode of the option 3x. An implementation of the first manner is shown in FIG. 4E(1) and FIG. 4E(2).

S411. The PDCP sublayers on the LTE side and the NR side of the terminal send a data transmission indication (including a data transmission indication and a no-data-transmission indication) to an RRC layer on the LTE side of the terminal. For example, data transmission detection is performed by using a TTI interrupt at the PDCP sublayer. Data transmission detection is performed at both the PDCP sublayer on the LTE side of the terminal and the PDCP sublayer on the NR side of the terminal, and detection is performed once in N TTIs. When detecting that there is data transmission, the PDCP sublayer sends a data transmission indication to the RRC layer on the LTE side of the terminal. When detecting that there is no data transmission, the PDCP sublayer sends a no-data-transmission indication to the RRC layer on the LTE side of the terminal. The RRC layer on the LTE side of the terminal maintains flags for the PDCP sublayer on the LTE side and the PDCP sublayer on the NR side of the terminal, which are Flag_Lte and Flag_Nr respectively. Initial values of the two flags are False. If the RRC layer on the LTE side of the terminal continuously receives the no-data-transmission indication sent by the PDCP sublayer on the LTE side of the terminal for M times, Flag_Lte is set to True, indicating that the terminal does not transmit service data on the LTE side within first duration. Once the RRC layer on the LTE side of the terminal receives the data transmission indication sent by the PDCP sublayer on the LTE side of the terminal, Flag_Lte is set to False. A manner of maintaining the Flag_Nr at the RRC layer on the LTE side of the terminal is similar to a manner of maintaining the Flag_Lte. Only when both the Flag_Lte and the Flag_Nr flags are True, the RRC layer on the LTE side of the terminal can determine that the terminal does not transmit the service data within the first duration.

S412. If the RRC layer on the LTE side of the terminal determines, based on the received data transmission indication, that the terminal does not transmit service data within the first duration, the RRC layer on the LTE side of the terminal releases the local resource of the first RRC connection of LTE, which includes: releasing the resource at the RRC layer of the terminal, sending an LTE resource release indication message to notify the L2 and the L1 on the LTE side of the terminal to release the corresponding RRC resource, and sending an NR RRC connection release indication message to notify the RRC layer on the NR side of the terminal to release the local NR RRC resource. After receiving the NR RRC connection release indication message, the RRC layer on the NR side of the terminal releases the local NR RRC resource, and sends an NR resource release indication message to notify the L2 and the L1 on the NR side of the terminal to release the corresponding RRC resource. After receiving NR resource release completion indications of the L2 and the L1 on the NR side of the terminal, the RRC layer on the NR side of the terminal sends an NR RRC connection release completion indication to the RRC layer on the LTE side of the terminal. After the RRC layer on the LTE side of the terminal receives resource release completion indications of the L2 and the L1 on the LTE side of the terminal and the NR RRC connection release completion indication sent by the RRC layer on the NR side of the terminal, the RRC layer on the LTE side of the terminal sends a second message, for example, a connection error indication message, to the NAS stratum of the terminal. In an optional implementation, the RRC layer on the LTE side of the terminal may send the connection error indication message to the NAS stratum on the LTE side of the terminal when releasing the local resource of the first RRC connection of LTE. In another optional implementation, after sending the connection error indication message to the NAS stratum on the LTE side of the terminal, the RRC layer on the LTE side of the terminal may release the local resource of the first RRC connection of LTE. It should be noted that the terminal does not receive the first RRC connection release message of LTE when releasing the local resource of the first RRC connection of LTE.

S413. After receiving the connection error indication message, the NAS stratum of the terminal sets an ECM status of the terminal from an ECM-CONNECTED state to an ECM-IDLE state, and sends a tracking area update request message to the RRC layer on the LTE side of the terminal, to send the tracking area update request message to an LTE air interface by using the RRC layer on the LTE side of the terminal. An Active Flag field in the tracking area update request message is filled with 0.

S414. After receiving the tracking area update request message, the RRC layer on the LTE side of the terminal detects that the local resource of the first RRC connection of LTE has been released, and initiates a procedure of establishing a second RRC connection of LTE. The RRC connection establishment procedure is described in Step S404 in FIG. 4A/4B, and details are not described herein again.

S415. After the second RRC connection of LTE is established, the RRC layer on the LTE side of the terminal sends the tracking area update request message to the LTE core network through the second RRC connection of LTE. The LTE core network identifies that the terminal has a residual context that is not released, and therefore sends a context release request to the LTE base station (not shown in the figure). After receiving the context release request, the LTE base station releases the residual resource on the LTE base station side, and sends an SGNB release request message (SGNB RELEASE REQUEST) to the NR base station through the X2 interface to release the residual NR RRC resource of the terminal. After releasing the residual RRC resource, the NR base station sends an SGNB release response message (SGNB RELEASE ACKNOWLEDGE) to the LTE base station. A method for identifying the residual context of the terminal by the LTE core network is specifically described in Step S405 in FIG. 4A/4B, and details are not described herein again. After receiving the SGNB release response message sent by the NR base station, the LTE base station sends the first RRC connection release message of LTE to the air interface of LTE. Because the terminal has released the local resource of the first RRC connection of LTE in advance, the terminal cannot receive the first RRC connection release message of LTE.

S416. The terminal and the network device continue to complete a tracking area update procedure. The LTE core network sends a tracking area update accept message to the NAS stratum of the terminal. After receiving the tracking area update accept message, the NAS stratum of the terminal sends a tracking area update complete message to the LTE core network.

S417. After receiving the second RRC connection release message of LTE sent by the LTE base station, the terminal releases the second RRC connection of LTE. Specifically, the connection management status maintained by the LTE core network for the terminal is the ECM-IDLE state, and it is detected that the Active Flag field in the tracking area update request message is 0, and the context release request message is sent to the LTE base station (not shown in the figure). After receiving the context release request message, the LTE base station sends the second RRC connection release message of LTE to the RRC layer of the terminal to release the newly established second RRC connection of LTE, so as to save power. The tracking area update procedure in Step S416 depends on the RRC connection. Therefore, the RRC connection can be released only after the tracking area update procedure is completed. A reason why the connection management status maintained by the LTE core network for the terminal is the ECM-IDLE state is specifically described in Step S407, and details are not described herein again.

An embodiment of the second manner is shown in FIG. 4F(1) and FIG. 4F(2).

S421. After receiving the no-data-transmission indication sent by the PDCP sublayer on the NR side of the terminal, the RRC layer on the NR side of the terminal sends a third message, for example, an SCG failure message (SCG Failure Information), to the network device, to notify the network device to release the SCG bearer. After receiving the SCG failure message, the LTE base station sends an SGNB release request message (SGNB RELEASE REQUEST) through the X2 interface, to notify the NR base station to release the RRC resource corresponding to the SCG bearer of the terminal. After receiving the SGNB release response message (SGNB RELEASE ACKNOWLEDGE) sent by the NR base station, the RRC layer of the LTE base station sends a fourth message, for example, an NR RRC connection release message, to the RRC layer on the LTE side of the terminal to release the RRC connection of NR, that is, release the SCG bearer of the terminal. A specific no-data-transmission detection function may be implemented by using the method provided in Step S401 in FIG. 4A/4B, and details are not described herein again.

S422. After receiving the no-data-transmission indication sent by the PDCP sublayer on the LTE side of the terminal, the RRC layer on the LTE side of the terminal detects that no SCG bearer exists on the current terminal (the SCG bearer has been released in Step 421), that is, no RRC connection of NR exists, and releases the local resource of the first RRC connection of LTE, which includes: releasing a resource at the RRC layer on the LTE side of the terminal, and sending an RRC resource release indication message to an L1 and an L2 on the LTE side of the terminal to release the corresponding RRC resources. After the RRC layer on the LTE side of the terminal receives RRC resource release completion indications of the L2 and the L1 on the LTE side of the terminal, the RRC layer on the LTE side of the terminal sends a second message, for example, a connection error indication message, to the NAS stratum of the terminal. A specific no-data-transmission detection function may be implemented by using the method provided in Step S401 in FIG. 4A/4B, and details are not described herein again. It should be noted that, if the RRC layer on the LTE side of the terminal detects, when receiving the no-data-transmission indication sent by the PDCP sublayer on the LTE side of the terminal, that the SCG bearer exists on the current terminal, the operation of this step is not performed. In an optional implementation, the RRC layer on the LTE side of the terminal may send the connection error indication message to the NAS stratum on the LTE side of the terminal when releasing the local resource of the first RRC connection of LTE. In another optional implementation, after sending the connection error indication message to the NAS stratum on the LTE side of the terminal, the RRC layer on the LTE side of the terminal may release the local resource of the first RRC connection of LTE. It should be noted that the terminal does not receive the first RRC connection release message of LTE when releasing the local resource of the first RRC connection of LTE.

S423. After receiving the connection error indication message, the NAS stratum of the terminal sets an ECM status of the terminal from an ECM-CONNECTED state to an ECM-IDLE state, and sends a tracking area update request message to the RRC layer on the LTE side of the terminal, to send the tracking area update request message to an LTE air interface by using the RRC layer on the LTE side of the terminal. An Active Flag field in the tracking area update request message is filled with 0.

S424. After receiving the tracking area update request message, the RRC layer on the LTE side of the terminal detects that the local resource of the first RRC connection of LTE has been released, and initiates a procedure of establishing a second RRC connection of LTE. The RRC connection establishment procedure is described in Step S404 in FIG. 4A/4B, and details are not described herein again.

S425. After the second RRC connection of LTE is established, the RRC layer on the LTE side of the terminal sends the tracking area update request message to the LTE core network through the second RRC connection of LTE. The LTE core network identifies that the terminal has a residual context that is not released, and therefore sends a context release request to the LTE base station (not shown in the figure). A method for identifving the residual context of the terminal by the LTE core network is specifically described in Step S405 in FIG. 4A/4B, and details are not described herein again. After receiving the context request message, the LTE base station detects that the SCG bearer currently does not exist on the terminal (the SCG bearer has been released in Step 421), releases the residual resource on the LTE base station side, and sends the first RRC connection release message of LTE to the terminal. Because the terminal has released the local resource of the first RRC connection of LTE in advance, the terminal cannot receive the first RRC connection release message of LTE.

S426. The terminal and the network device complete a tracking area update procedure. The LTE core network sends a tracking area update accept message to the NAS stratum of the terminal. After receiving the tracking area update accept message, the NAS stratum of the terminal sends a tracking area update complete message to the LTE core network.

S427. After receiving the second RRC connection release message of LTE sent by the LTE base station, the terminal releases the second RRC connection of LTE. Specifically, the connection management status maintained by the LTE core network for the terminal is the ECM-IDLE state, and it is detected that the Active Flag in the tracking area update request message is 0, and the context release request message is sent to the LTE base station (not shown in the figure). After receiving the context release request message, the LTE base station sends the second RRC connection release message of LTE to the RRC layer of the terminal to release the newly established second RRC connection of LTE, so as to save power. The tracking area update procedure in Step S426 depends on the RRC connection. Therefore, the RRC connection can be released only afler the tracking area update procedure is completed. A reason why the ECM connection management status of the terminal is the ECM-IDLE state is specifically described in Step S407, and details are not described herein again.

FIG. 4E(1), FIG. 4E(2), FIG. 4F(I), and FIG. 4F(2) show two embodiments in an NSA networking mode of the option 3x. In FIG. 4E(1) and FIG. 4E(2), a manner of simultaneously releasing RRC connections of LTE and NR is used. To be specific, after detecting that there is no data transmission in LTE and NR, a terminal triggers, by using a tracking area update procedure, to simultaneously release the RRC connections of LTE and NR. In FIG. 4F(1) and FIG. 4F(2), an RRC connection is released step by step. To be specific, after detecting that there is no data transmission in NR, the terminal actively reports an exception message to request to release the RRC connection of NR. Then, after detecting that there is no data transmission in LTE, the terminal triggers release of the RRC connection of LTE by using the tracking area update procedure.

Certainly, in another NSA networking mode, RRC connections may also be released in a manner similar to the foregoing manner. Details are not described one by one in this application.

In this embodiment of this application, the terminal instead of the base station determines whether service transmission of the terminal ends. In this way, a moment at which the service transmission of the terminal ends can be accurately determined as soon as possible. The terminal may release the local RRC connection after determining that the service transmission ends, and initiate a corresponding NAS procedure to establish a new RRC connection. Finally, the network device sends an RRC connection release message to the terminal, according to an indication of the NAS message and a standard protocol procedure, to release the new RRC connection. In this way, the terminal can quickly release the RRC connection after the service transmission ends, thereby reducing power consumption of the terminal.

In addition, the network device in this embodiment of this application uses a standard protocol procedure, and does not need to perform additional adaptation. Only modification needs to be performed on a single side of the terminal. Therefore, fast implementation and application can be performed, and this is very flexible.

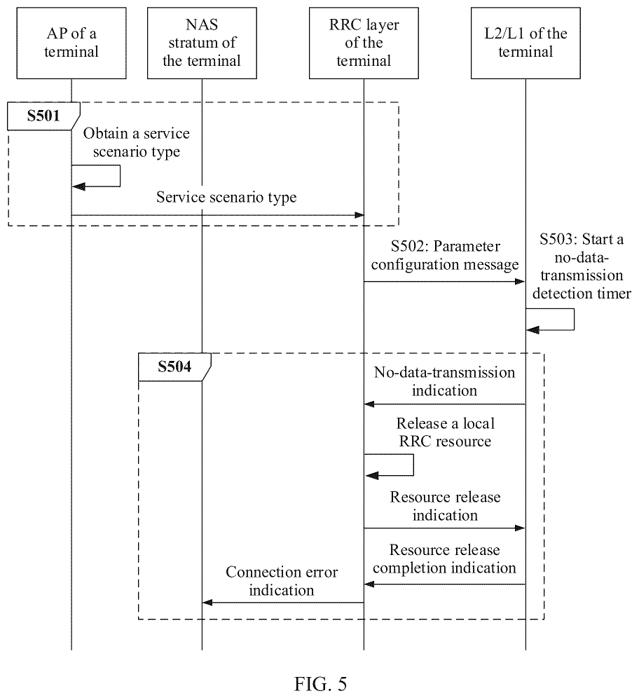

In the embodiment shown in FIG. 4A, the terminal performs data transmission service detection based on fixed duration, and service scenario differentiation of the terminal is not considered. The following provides an embodiment of setting no-data-transmission detection duration (that is, the first duration) based on different service scenarios of the terminal. A specific embodiment procedure is shown in FIG. 5, and the specific procedure includes the following steps.

S501. An application processor AP of a terminal obtains a service scenario type of the current terminal, and sends the service scenario type to an RRC layer of the terminal. In an optional implementation, the application processor AP of the terminal may send the service scenario type to the RRC layer of the terminal by using an AT (Attention) instruction. In an Android system, an isScreenOn interface may be invoked to obtain a screen status, and an isWifiConnected interface may be invoked to obtain a Wi-Fi connection status.

The service scenario type of the terminal includes screen off and Wi-Fi not connected, screen on and Wi-Fi not connected. Wi-Fi connected, or a sleep mode. For example, if it is obtained, through the isScreenOn interface, that a screen is in an off state, and it is obtained, through the isWifiConnected interface, that Wi-Fi is not connected, the service scenario type of the terminal is the screen off and Wi-Fi not connected. If it is obtained, through the isScreenOn interface, that a screen is in an on state, and it is obtained, through the isWifiConnected interface, that Wi-Fi is not connected, the service scenario type of the terminal is the screen on and Wi-Fi not connected. If it is obtained, through the isWifiConnected interface, that Wi-Fi is connected, the service scenario type of the terminal is Wi-Fi connected.

Ambient light, proximity light, motion, screen-off, and screen-lock duration are mainly used to determine the sleep mode. A probability that the user is in the sleep mode at a current moment is high when it is determined by using a historical record, and a probability that the user is in the sleep mode in a light-off state is also high when it is determined by using the current ambient light. Whether the user is in the sleep mode is comprehensively determined based on the foregoing two probabilities. For example, when the probability exceeds 90%, it is considered that the user is in the sleep mode. It should be noted that, the foregoing determining of the sleep mode considers a screen-off factor and also considers another factor. Therefore, the terminal in the sleep mode is definitely in the screen-off state, but the terminal in the screen-off state is not necessarily in the sleep mode. Certainly, the service scenario type may be alternatively obtained by using another method. This is not limited in this embodiment of this application.

S502. After receiving the service scenario type, the RRC layer of the terminal sends a parameter configuration message to a PDCP sublayer of an L2 of the terminal. The parameter configuration message may be a service scenario type received by the RRC layer of the terminal, or may be the first duration obtained by the RRC layer of the terminal by using the service scenario type.

Optionally, after receiving the service scenario type, the RRC layer of the terminal obtains the first duration in a table lookup manner.

Optionally, after receiving the service scenario type, the RRC layer of the terminal may alternatively obtain the first duration by invoking a subfunction, and the subfunction receives the service scenario type as an input parameter.

S503. After receiving the parameter configuration message, the PDCP sublayer of the L2 of the terminal starts a no-data-transmission detection timer. If the parameter configuration message received by the PDCP sublayer of the L2 of the terminal is the service scenario type, the PDCP sublayer of the L2 of the terminal may obtain the first duration by looking up a table or invoking the subfunction, and then start the no-data-transmission detection timer based on the duration. If the parameter configuration message received by the PDCP sublayer of the L2 of the terminal is the first duration, the PDCP sublayer of the L2 of the terminal directly starts the no-data-transmission detection timer based on the duration.

S504. After the no-data-transmission detection timer expires, the PDCP sublayer of the L2 of the terminal sends a no-data-transmission indication message to the RRC layer of the terminal. After receiving the no-data-transmission indication message, the RRC layer of the terminal releases a local RRC resource, and sends a resource release indication message to the L2 and the L1 of the terminal to release the corresponding RRC resources. After the RRC layer of the terminal receives resource release completion indications of the L2 and the L1 of the terminal, the RRC layer of the terminal sends a second message, for example, a connection error indication message, to a NAS stratum of the terminal.

Optionally, Steps S503 to S504 may be alternatively implemented in the TTI interrupt manner provided in Step S401 in FIG. 4A. That is, a service transmission status is detected by using a TTI interrupt at the PDCP sublayer of the L2 of the terminal. After receiving a specific quantity of consecutive no-data-transmission indications, the RRC layer of the terminal sends the resource release indication message to the L1 and the L2 of the terminal to release the corresponding RRC resources. It should be noted that, in an implementation of the TTI interrupt, the RRC layer of the terminal does not need to send the parameter configuration message to the PDCP sublayer of the L2 of the terminal, and the RRC layer of the terminal directly obtains the first duration by using the service scenario type, to determine that the terminal does not transmit service data within the first duration. After receiving resource release completion indications of the L2 and the L1 of the terminal, the RRC layer of the terminal sends a connection error indication message to the NAS stratum of the terminal.

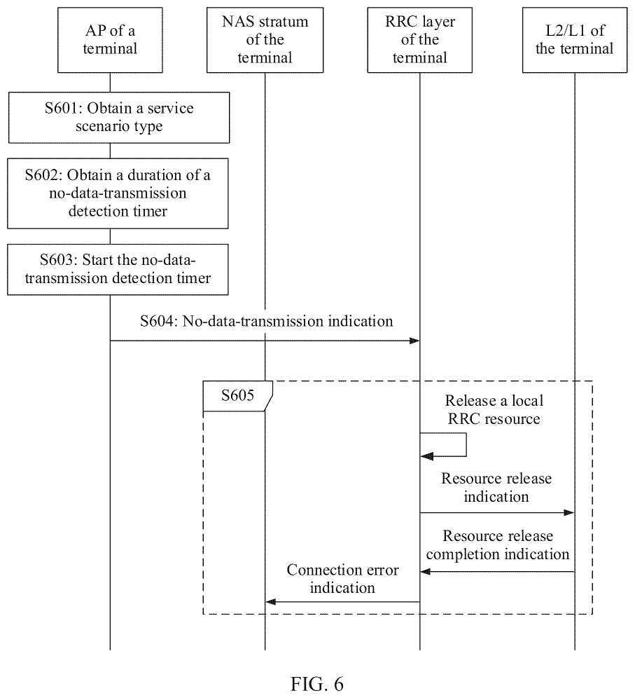

Optionally, in Step S501, after identifying a specific service scenario type, the application processor AP of the terminal obtains the first duration based on the service scenario type, and then directly starts the no-data-transmission detection timer based on the first duration to perform no-data-transmission detection. A specific procedure is shown in FIG. 6, and includes the following steps.

S601: The application processor AP of the terminal detects the service scenario type of the current terminal.

S602. The application processor AP of the terminal obtains the first duration based on the detected service scenario type, and specifically, may obtain the duration of the no-data-transmission detection timer by looking up a table or invoking a subfunction.

S603. The application processor AP of the terminal starts the no-data-transmission detection timer based on the obtained first duration, and restarts the no-data-transmission detection timer if data transmission is detected. Specifically, in the Android system, the application processor AP of the terminal may obtain, through an interface TrafficStats.getMobileRxBytes, a quantity of bytes received by the terminal, and obtain, through an interface TrafficStats.getMobileTxBytes, a quantity of bytes sent by the terminal. When the quantity of sent bytes and the quantity of received bytes are zero, no data is transmitted by the terminal.

S604. After the no-data-transmission detection timer expires, the application processor AP of the terminal sends a no-data-transmission indication to the RRC layer of the terminal. In an optional implementation, the application processor AP of the terminal may send the no-data-transmission indication to the RRC layer of the terminal by using an AT instruction.

S605. After receiving the no-data-transmission indication message, the RRC layer of the terminal releases a local RRC resource, and sends a resource release indication message to notify the L1 and the L2 of the terminal to release corresponding RRC resources. After receiving resource release completion indications of the L2 and the L1 of the terminal, the RRC layer of the terminal sends a second message, for example, a connection error indication message, to the NAS stratum of the terminal.

Processing performed after the NAS stratum of the terminal receives the connection error indication message is the same as the processing in the embodiment shown in FIG. 4A. Details are not described herein again.

Optionally, after obtaining the first duration, the application processor AP of the terminal may also send the duration to the RRC layer of the terminal or the PDCP sublayer of the L2 of the terminal to complete a no-data-transmission detection function. A specific implementation is similar to that described above, and a difference lies in that the no-data-transmission detection function is implemented by different modules of the terminal.

Optionally, the terminal may directly obtain the first duration by using a status of a component, and then complete the no-data-transmission detection function by using different modules of the terminal.

In this embodiment of this application shown in FIG. 5, the first duration of the terminal is determined based on different service scenarios. In this way, differentiated processing can be implemented on different service scenario types of the terminal, so that more power of the terminal is saved.

TABLE 1.1

| Scenario 1 | First duration | Remark |
|---|---|---|
| Sleep mode/Wi-Fi | T1 = 2 seconds | There is no need to wait for an |
| connected | | inactivity timer on the network |
| | | side to expire. |

TABLE 1.2

| Scenario 2 | First duration | Remark |
|---|---|---|
| Screen off and | T2 = 12 seconds | The judgment duration |
| Wi-Fi not connected | | is in the middle. |

TABLE 1.3

| Scenario 3 | First duration | Remark |
|---|---|---|
| Screen on and | T3 = 24 seconds | The judgment time is longer, |
| Wi-Fi not connected | | reducing impact on a service. |

Table 1.1. Table 1.2, and Table 1.3 provide configurations of the first duration in three typical service scenarios. Table 1.1 shows the first duration configuration of the sleep mode and the Wi-Fi connected mode. In the sleep mode, the terminal only periodically processes a heartbeat packet or receives small-sized traffic of a single application, for example, WeChat. After an RRC connection of the terminal is established, the terminal can receive service data within only 1 second. In this case, the terminal can actively initiate an RRC connection release request before the inactivity timer on the network side expires. This saves at least 90% of power (it is assumed that the duration of the no-data-transmission timer of the terminal is 2 seconds and duration of the inactivity timer on the network side is set to 20 seconds). The inactivity timer on the network side herein is the inactivity timer maintained by the base station for the terminal in FIG. 3A. In a Wi-Fi connected scenario, the terminal mainly transmits data on a Wi-Fi connection, and the cellular network is basically not used. In this case, setting of the first duration may be consistent with setting of the sleep mode.

Table 1.2 shows the first duration configuration in the screen off and Wi-Fi not connected mode. It is considered that behavior of the user when the terminal screen is on lasts for a period of time after the screen is off, the first duration of the terminal may be configured in the middle, for example, set to 12 seconds (a typical configuration of the duration of the inactivity timer on the network side is 20 seconds).

Table 1.3 shows the first duration configuration in the screen on and Wi-Fi not connected mode. When the terminal screen is on, the user continuously uses cellular data in most of the time. To reduce impact on use of the user, the first duration needs to be set to a relatively large value, for example, set to 24 seconds (a typical configuration of the duration of the inactivity timer on the network side is 20 seconds).

Further, in this embodiment of this application, differentiated processing is performed on service data of different applications of the terminal. Specifically, an application in the terminal corresponds to a unique user identity (UID) on the application processor AP side. Before transmitting data to the network, the application in the terminal establishes a socket connection to the network. The terminal records a mapping table between the UID and an IP 5-tuple (a source address, a source port number, a destination address, a destination port number, and a protocol type). When receiving or sending a data packet, the application processor AP of the terminal parses an IP packet header, and finds a UID based on the IP 5-tuple and the stored mapping table between the UID and the IP 5-tuple, to determine an application corresponding to the data packet.

TABLE 2

| Application | First duration | | Remark |
|---|---|---|---|
| Arena of Valor | 24 | s | High latency requirement |
| NetEase News | 12 | s | News browsing is an unexpected |
| | | | service. |
| Codoon Sports | 2 | s | The data transmission interval |
| | | | is relatively long. |

Table 2 provides an example of first duration corresponding to some typical applications. When the application processor AP of the terminal identifies a data packet of an Arena of Valor game application, because the Arena of Valor game application has a relatively high requirement on a delay, the first duration may be set to be slightly longer than the duration of the inactivity timer on the network side, for example, set to 24 seconds (a typical configuration of the duration of the inactivity timer on the network side is 20 seconds). When the application processor AP of the terminal identifies a data packet of a NetEase News client, because news browsing by the user is an unexpected service, the first duration of the terminal may be configured in the middle, for example, set to 12 seconds (a typical configuration of the duration of the inactivity timer on the network side is 20 seconds). When the application processor AP of the terminal identifies a data packet of a sports and health application, for example, the Codoon Sports, because the amount of data exchanged between the application and the network is small and the time interval is relatively large, the first duration of the terminal may be configured to be shorter, for example, set to 2 seconds (a typical configuration of the duration of the inactivity timer on the Network side is 20 seconds).

Specifically, the application processor AP of the terminal may classify applications into three types: a type A, a type B, and a type C, and create three corresponding timers respectively, where initial states of the timers are all stopped states. The type-A application corresponds to shortest first duration, for example, the duration is 2 s; the type-B application corresponds to intermediate first duration, for example, the duration is 12 s; and the type-C application corresponds to longest first duration, for example, the duration is 24 s. The application processor AP of the terminal identifies an application to which a data packet belongs based on the data packet, and then obtains a type of the corresponding application based on the application. If a timer corresponding to the type of the application is running, the timer is restarted. If a timer corresponding to the type of the application is in a stopped state, the timer is started. When a timer expires, the statuses of the other two timers are checked. If the other two timers are in the stopped state, the application processor AP of the terminal sends a no-data-transmission indication to the RRC layer of the terminal. In an optional implementation, the application processor AP of the terminal may send the no-data-transmission indication to the RRC layer of the terminal by using an AT instruction.

Processing performed after the RRC layer of the terminal receives the no-data-transmission indication message is consistent with the processing in the embodiment shown in FIG. 4A. Details are not described herein again.

After the application processor AP of the terminal identifies the application type corresponding to the data packet, the function of completing detection of no data transmission based on the application type may be completed in different modules of the terminal. For example, the application type may be sent to the RRC layer of the terminal, and the RRC layer of the terminal completes detection of no data transmission.

In this embodiment, requirements of different applications on a data transmission delay are considered, and the first duration is set based on different requirements, so that user experience can be prevented from being affected by releasing an RRC connection in advance by the terminal.

In all the foregoing embodiments of this application, the terminal determines, by using data transmission detection, to release the RRC connection, and the terminal may alternatively determine, by using another method, to release the RRC connection. For example, whether the terminal needs to release the RRC connection is predicted in a machine learning manner. Specifically, the terminal determines, based on an identified application type, a component status, and recorded historical information about data transmission in different application scenarios and different component statuses, whether the terminal transmits data in a next period of time. If the terminal predicts that there is no data to be transmitted in the next period of time, the terminal determines that the RRC connection needs to be released, and triggers an RRC connection release procedure by using the method in this embodiment of this application.

The following describes in detail triggering the RRC connection release by the terminal in this embodiment of this application.

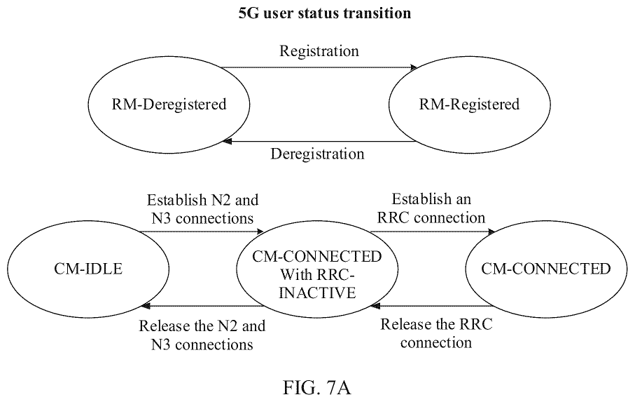

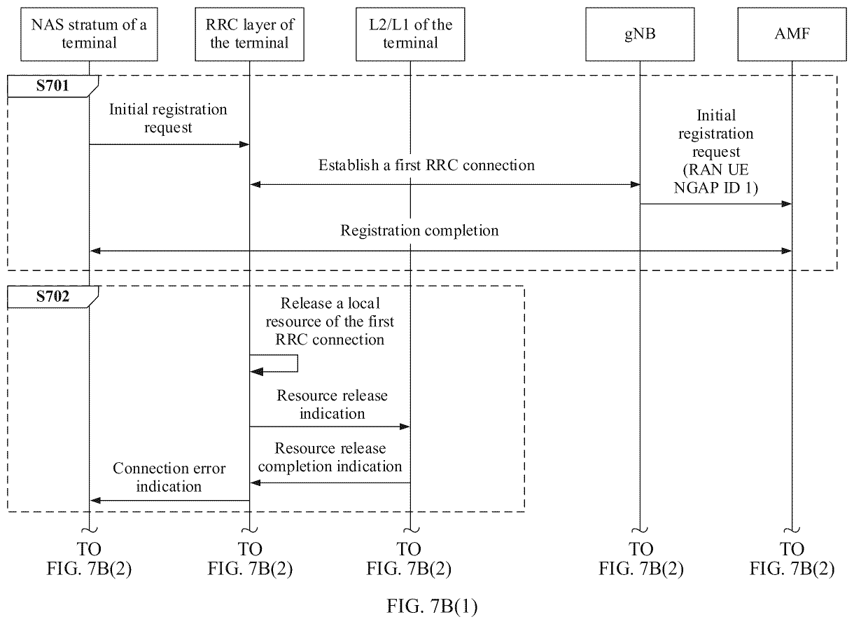

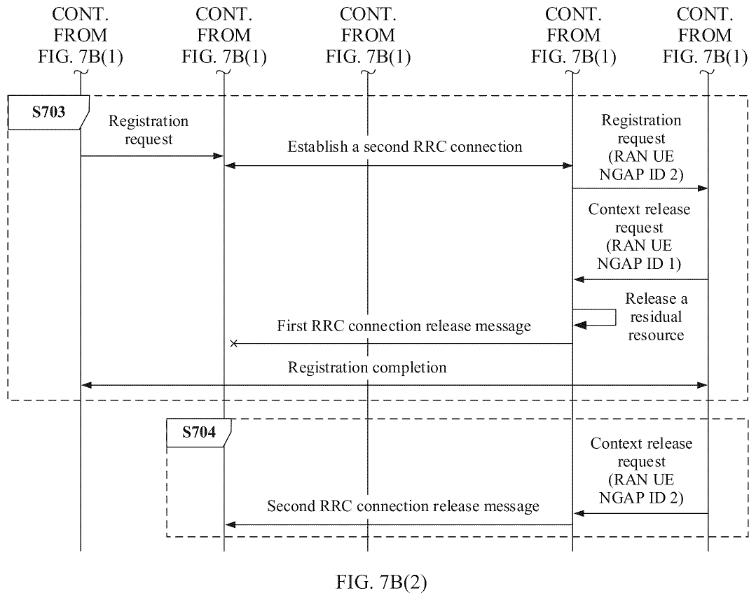

In an NR standalone networking system, a user status corresponding to the terminal is classified into a registration management (Registration Management, RM) state and a connection management (Connection Management, CM) state. In the NR system, an RRC Inactive state is added to the RRC status, so that the network can quickly restore the connection of the terminal when data needs to be transmitted, and a requirement for power saving is considered. The specific transition of the user status is shown in FIG. 7A. The registration management state of the user is transited through registration and deregistration. The transition of the connection management status of the user includes the establishment and release of a connection between the terminal and a base station (namely, RRC connection establishment and release), and establishment and release of a connection between the base station and a core network (that is, N2 and N3 connection establishment and release). The connection between the base station gNB and an AMF of the core network is an N2 connection, and the connection between the base station gNB and the user plane function (UPF) of the core network is an N3 connection. In an embodiment of this application, a main procedure in which a terminal in an NR system triggers RRC connection release is shown in FIG. 7B(1) and FIG. 7B(2).

S701. The terminal performs initial registration with a network to obtain an authorized receiving service. In the NR system, the terminal needs to register with the network to obtain the authorized receiving service and start mobility tracking and reachability. The terminal in an RM-Deregistered state, a CM-IDLE state, or an RRC-IDLE state initiates a registration procedure, and the NAS stratum of the terminal sends an initial registration request message to an RRC layer of the terminal. After receiving the initial registration request message, the RRC layer of the terminal initiates a first RRC connection establishment procedure (namely, a random access procedure). After the first RRC connection is established, the base station gNB allocates a user identity RAN UE NGAP ID 1 to the terminal, and sends the user identity RAN UE NGAP ID 1 and the initial registration request message to the AMF (access and mobility management function) entity of the core network. After receiving the initial registration request of the terminal, the AMF entity of the core network completes the registration procedure together with the terminal. After the registration is completed, the terminal enters the RM-Registered state, the CM-CONNECTED state, and the RRC-CONNECTED state.

S702. The terminal releases a local resource of the first RRC connection, and sends a message to notify the NAS stratum of the terminal. Specifically, when the terminal detects that no service data is transmitted within the first duration, the RRC layer of the terminal releases the local resource of the first RRC connection, which includes: releasing a resource at the RRC layer of the terminal, and sending a resource release indication message to an L1 and an L2 of the terminal to release the corresponding RRC resources. After the RRC layer of the terminal receives resource release completion indications of the L1 and the L2 of the terminal, the RRC layer of the terminal sends a second message, for example, a connection error indication message, to the NAS stratum of the terminal. In an optional implementation, when releasing the local resource of the first RRC connection, the RRC layer of the terminal may send the connection error indication message to the NAS stratum of the terminal. In another optional implementation, the RRC layer of the terminal may release the local resource of the first RRC connection after sending the connection error indication message to the NAS stratum of the terminal. It should be noted that, when releasing the local resource of the first RRC connection, the terminal does not receive the first RRC connection release message sent by the network device.

S703. After receiving the connection error indication message, the NAS stratum of the terminal sets the CM status of the terminal from the CM-CONNECTED state to the CM-IDLE state, and sends a registration request message to the RRC stratum of the terminal. In this case, because the terminal has released the local resource of the first RRC connection in advance, the RRC layer of the terminal initiates a procedure of establishing a second RRC connection. After the second RRC connection is established, the base station gNB allocates a new user identity RAN UE NGAP ID 2 to the terminal, and sends the new user identity RAN UE NGAP ID 2 and the registration request message to the AMF entity of the core network. Because the RAN UE NGAP ID 2 is a user identity newly allocated by the base station gNB to the terminal, and a user corresponding to the identity has not completed a registration procedure, a connection management status maintained by the network device for the user corresponding to the RAN UE NGAP ID 2 is the CM-IDLE state. The AMF entity of the core network detects that the RAN UE NGAP ID 1 and the RAN UE NGAP ID 2 correspond to a same terminal. Therefore, the AMF entity of the core network sends a context release request message corresponding to the RAN UE NGAP ID 1 to the base station gNB. After receiving the context release request message, the base station gNB releases a residual resource on the base station gNB side, and sends the first RRC connection release message through the first RRC connection, to release the first RRC connection corresponding to the RAN UE NGAP ID 1. In this case, because the terminal has released the local resource of the first RRC connection in advance, the terminal cannot receive the first RRC connection release message. In addition, after receiving the initial registration request of the terminal, the AMF entity of the core network completes the registration procedure together with the terminal.

S704. After receiving the context release request that corresponds to the user identity RAN UE NGAP ID 2 and that is sent by the AMF entity of the core network, the base station gNB sends a second RRC connection release message to the RRC layer of the terminal. Specifically, the AMF entity of the core network detects that a Follow-on request field in the registration request message is 0, and the connection management status maintained by the AMF entity of the core network for the user corresponding to the RAN UE NGAP ID 2 is the CM-IDLE state. According to processing of the standard protocol, when the AMF entity of the core network detects that the Follow-on request field in the registration request message is 0, which indicates that the terminal has no service requirement on the second RRC connection, and the connection management status maintained by the AMF entity of the core network for the user corresponding to the RAN UE NGAP ID 2 is the CM-IDLE state, the AMF entity of the core network delivers a context release request message corresponding to the RAN UE NGAP ID 2 to indicate the base station gNB to release the second RRC connection newly established by the terminal, so as to save power.

In the NR system, the registration request message sent by the terminal needs to include a registration type information element. The registration type information element includes two fields: a Follow-on request (FOR) and a 5GS registration type value, which occupy 4 bits in total, as shown in Table 3.

TABLE 3

| 8 | 7 | 6 | 5 | 4 | 3 | 2 | 1 |
|---|---|---|---|---|---|---|---|
| z | z | z | z | z | z | z | z |

| | | |
|---|---|---|
| 5GS registration type IEI | FOR | 5GS registration type value |

The Follow-on request (FOR) field occupies 1 bit. A value 0 indicates that there is no subsequent request waiting, and a value 1 indicates that there is a subsequent request waiting. The 5GS registration type value field occupies 3 bits, and mainly has the following values, as shown in Table 4.

TABLE 4

| | | | | |
|---|---|---|---|---|
| Bit | 3 | 2 | 1 | Description |

| | | | |
|---|---|---|---|
| 0 | 0 | 1 | Initial registration |
| 0 | 1 | 0 | Mobility registration updating |
| 0 | 1 | 1 | Periodic registration updating |
| 1 | 0 | 0 | Emergency registration |
| 1 | 1 | 1 | Reserved |

For the 5GS registration type value, if the value is 001, it indicates that the registration message is an initial registration message, if the value is 010, it indicates that the registration message is a mobility registration message, if the value is 011, it indicates that the registration message is a periodic registration message, if the value is 100, it indicates that the registration message is an emergency registration message, and if the value is 111 or another value, the value is a reserved value and is not used.

In Step S703 in FIG. 7B(1) and FIG. 7B(2), the NAS stratum of the terminal sends a registration request message to the network device. The Follow-on request in the registration message is filled with 0, indicating that there is no subsequent request waiting, that is, the RRC connection may be released. The 5GS registration type value may be filled with “010” or “011”, indicating that a mobility registration request or a periodic registration request is sent. According to the standard protocol, when detecting that the Follow-on request in the registration request sent by the terminal in the CM-IDLE state is 0, the AMF of the core network sends a context release request to the base station gNB. Then, the base station gNB releases the RRC connection.

In addition, the registration request sent by the terminal in Step S703 further needs to include a 5GS mobile identity information element, and the 5GS mobile identity information element may be a unique identity of the terminal, for example, a Subscription Concealed Identifier (SUCI), a 5G Global Unique Temporary Identifier (5G-GUTI), or an International Mobile Equipment Identity (IMEI). Based on the RAN UE NGAP ID allocated by the base station gNB to the user, if the core network identifies that a same terminal uses different RAN UE NGAP IDs during registration, the core network releases the context of the user corresponding to the old RAN UE NGAP ID.

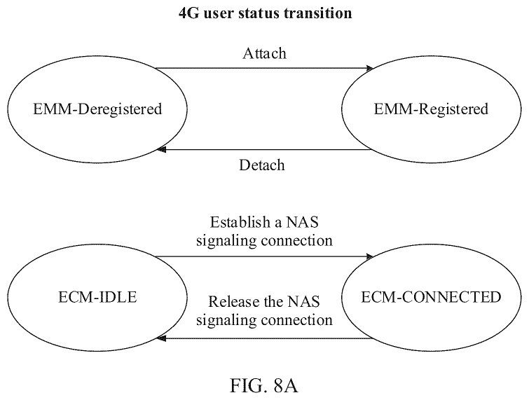

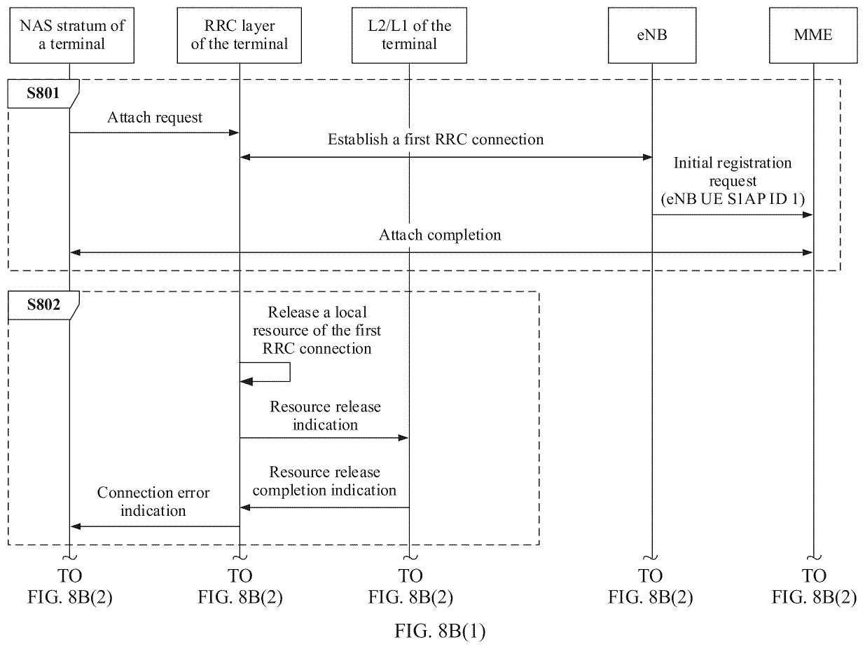

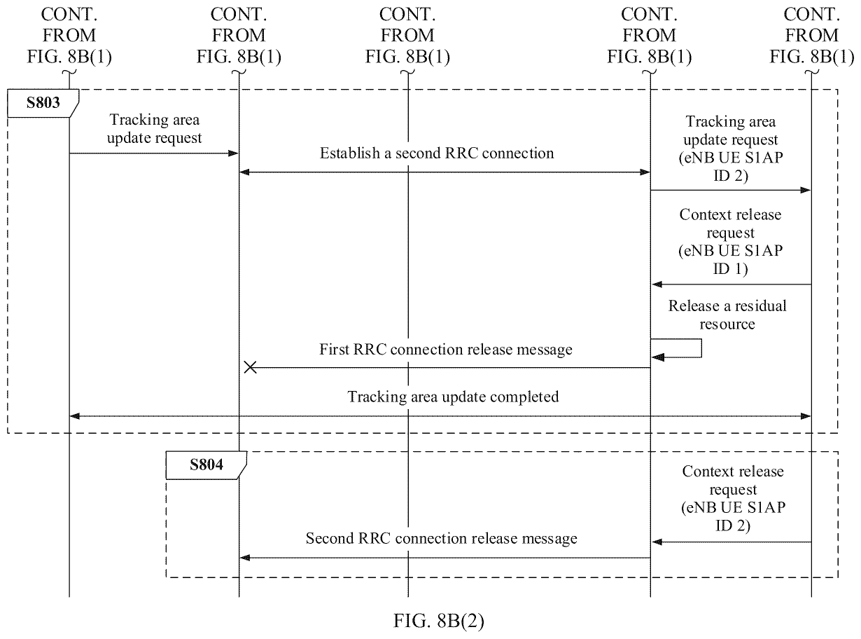

In the LTE system, the user status corresponding to the terminal is classified into an EPS mobility management (EPS Mobility Management, EMM) state and an EPS connection management (EPS Connection Management, ECM) state. The specific transition of the user status is shown in FIG. 8A. A user mobility management state is transited in an attach and detach manner. The connection management status of a user is transited by using signaling at the NAS stratum. In an embodiment of this application, a main procedure in which a terminal in an LTE system triggers RRC connection release is shown in FIG. 8B(1) and FIG. 8B(2).

S801. The terminal initially attaches to a network to obtain an authorized receiving service. In the LTE system, the terminal can obtain a network service only after the terminal is attached to the network. The terminal in the EMM-Deregistered state, the ECM-IDLE state, and the RRC-IDLE state initiates an attach procedure. A NAS stratum of the terminal sends an attach request message to an RRC layer of the terminal. After receiving the attach request message, the RRC layer of the terminal initiates a first RRC connection establishment procedure (namely, a random access procedure). After the first RRC connection is established, the base station eNB allocates an eNB UE S1AP ID 1 to the terminal, and sends the eNB UE S1AP ID 1 to an MME (mobility management entity) of a core network together with the attach request message. After receiving the attach request message of the terminal, the MME of the core network completes the attach procedure together with the terminal. After the attach procedure is completed, the terminal enters the EMM-Registered, ECM-CONNECTED, and RRC-CONNECTED states.

S802. The terminal releases a local resource of the first RRC connection and sends a message to notify the NAS stratum of the terminal. Specifically, when the terminal detects that no service data is transmitted within first duration, the RRC layer of the terminal releases the local resource of the first RRC connection, which includes: releasing a resource at the RRC layer of the terminal, and sending a resource release indication message to an L1 and an L2 of the terminal to release the corresponding RRC resources. After the RRC layer of the terminal receives resource release completion indications of the L1 and the L2 of the terminal, the RRC layer of the terminal sends a second message, for example, a connection error indication message, to the NAS stratum of the terminal. In an optional implementation, when releasing the local resource of the first RRC connection, the RRC layer of the terminal may send the connection error indication message to the NAS stratum of the terminal. In another optional implementation, the RRC layer of the terminal may release the local resource of the first RRC connection after sending the connection error indication message to the NAS stratum of the terminal. It should be noted that, when releasing the local resource of the first RRC connection, the terminal does not receive the first RRC connection release message sent by the network device.

S803. The terminal initiates a tracking area update (Tracking Area Update, TAU) procedure. After receiving the connection error indication, the NAS stratum of the terminal sets the ECM status of the terminal from the ECM-CONNECTED state to the ECM-IDLE state, and sends a tracking area update request message to the RRC layer of the terminal. In this case, because the RRC layer of the terminal has released the local resource of the first RRC connection in advance, the RRC layer of the terminal initiates a procedure of establishing a second RRC connection. After the second RRC connection is established, the base station eNB allocates an eNB UE S1AP ID 2 to the terminal, and sends the eNB UE S1AP ID 2 and the tracking area update request message to the MME of the core network. Because the eNB UE S1AP ID 2 is a user identity newly allocated by the base station eNB to the terminal, and a user corresponding to the user identity has not completed tracking area update, a connection management status maintained by the network device for the user corresponding to the eNB UE S1AP ID 2 is the ECM-IDLE state. The MME of the core network detects that the eNB UE S1AP ID 1 and the eNB UE S1AP ID 2 correspond to a same terminal. Therefore, the MME of the core network sends a context release request message corresponding to the eNB UE S1AP ID 1 to the base station eNB. After receiving the context release request message, the base station eNB releases a residual resource on the base station eNB side, and sends the first RRC connection release message through the first RRC connection, to release the first RRC connection corresponding to the eNB UE S1AP ID 1. In this case, because the terminal has released the local resource of the first RRC connection in advance, the terminal cannot receive the RRC connection release message. In addition, after receiving the tracking area update request message of the terminal, the MME of the core network completes the tracking area update procedure together with the terminal.

S804. After receiving the context release request message that corresponds to the user identity eNB UE S1AP ID 2 and that is sent by the MME of the core network, the base station eNB sends a second RRC connection release message to the RRC layer of the terminal. The MME of the core network detects that the Active Flag field in the tracking area update message is 0, that is, it is indicated that the terminal has no service requirement on the second RRC connection, and the connection management status maintained by the MME of the core network for the user corresponding to the eNB UE S1AP ID 2 is the ECM-IDLE state. According to processing of the standard protocol, when detecting that the Active Flag field in the tracking area update message is 0 and the connection management status maintained by the MME of the core network for the user corresponding to the eNB UE S1AP ID 2 is the ECM-IDLE state, the MME of the core network sends a context release request message corresponding to the eNB UE S1AP ID 2 to indicate the base station eNB to release the second RRC connection newly established by the terminal, so as to save power.

In the LTE system, the tracking area update request message sent by the terminal needs to include an EPS update type information element. The EPS update type information element includes two fields: an Active Flag and an EPS update type value, which occupy 4 bits in total, as shown in Table 5.

TABLE 5

| 8 | 7 | 6 | 5 | 4 | 3 | 2 | 1 |
|---|---|---|---|---|---|---|---|
| z | z | z | z | z | z | z | z |

| | | |
|---|---|---|
| EPS update type IEI | “Active” flag | EPS update type value |

The Active Flag field occupies 1 bit. If a value is 0, it indicates that no bearer establishment request exists. If a value is 1, it indicates that a bearer establishment request exists. The EPS update type value field occupies 3 bits, and has the following values, as shown in Table 5.

TABLE 6

| Bit | 3 | 2 | 1 | Description |
|---|---|---|---|---|
| | 0 | 0 | 0 | TA updating |
| | 0 | 0 | 1 | Combined TA/LA updating |
| | 0 | 1 | 0 | Combined TA/LA updating with IMSI attach |
| | 0 | 1 | 1 | Periodic updating |
| | 1 | 0 | 0 | Unused; shall be interpreted as “TA updating”, |
| | | | | if received by the network. |
| | 1 | 0 | 1 | Unused; shall be interpreted as “TA updating”, |
| | | | | if received by the network. |

For the EPS update type value, if a value is “000”, it indicates that the type of the tracking area update message is normal tracking area update, if a value is “001”, it indicates that the type of the tracking area update message is combined TA and LA tracking area update, if a value is “010”, it indicates that the type of the tracking area update message is combined TA and LA tracking area update with IMST attach, and if a value is “011”, it indicates that the type of the tracking area update message is periodic tracking area update. Other values are not used.

In this embodiment of this application, after receiving the connection error indication, the NAS stratum of the terminal sends the tracking area update message to the network device. The Active Flag is filled with 0, indicating that there is no bearer establishment request, that is, the RRC connection may be released. The EPS update type value may be filled with “000”, “001”, “010”, or “011”. According to the standard protocol, the MME of the core network detects that Active Flag in the tracking area update request sent by the terminal in the ECM-IDLE state is 0, and sends a context release request to the base station eNB, so that the base station eNB releases the RRC connection.

In addition, the tracking area update message sent by the terminal needs to further include an EPS mobile identity information element. The EPS mobile identity information element may be an International Mobile Subscriber Identity (IMSI), a Globally Unique Temporary UE Identity (GUTI), or an International Mobile Equipment Identity (IMEI), and represents a unique identity of the terminal. Based on the eNB UE S1AP ID allocated by the base station eNB to the user, if the core network identifies that a same terminal uses different eNB UE S1AP IDs during the tracking area update, the core network releases the context of the user corresponding to the old eNB UE S1AP ID.

It should be noted that, in FIG. 7B(1), FIG. 7B(2), FIG. 8B(1), and FIG. 8B(2), both the terminal and the network device newly establish a second RRC connection. When the terminal establishes the second RRC connection to the network device, the network device may have changed compared with a network device connected to the terminal when the first RRC connection exists, including a change of a base station device and a core network device. For example, both the base station device and the core network device are changed, or only the base station device is changed. An NR non-standalone networking system is used as an example. When only the base station device is changed, the terminal establishes a second RRC connection to the new base station device. When receiving the registration request message, the core network device detects that a residual resource of the terminal is not released. Therefore, the core network device sends a context release request message to the old base station to request to release the resource of the first RRC connection. When both the base station device and the core network device are changed, the terminal establishes a second RRC connection to the new base station device. When receiving the registration request message, the new core network device sends a message to the old core network device to obtain information about the terminal. After receiving the message, the old core network device sends the information about the terminal to the new core network device, and sends a context release request message to the old base station to request to release the resource of the first RRC connection.

If the terminal does not release the local RRC connection resource after completing detection of no data transmission, and still sends the registration request message or the tracking area request update message to the network device by using the first RRC connection, because a status maintained by the network device for the terminal user is still the CM-CONNECTED state or the ECM-CONNECTED state, according to the standard protocol, the network device does not send an RRC connection release message to the terminal even if the network device detects that the terminal does not need to establish a bearer or does not request to wait subsequently. Therefore, the RRC connection cannot be released.

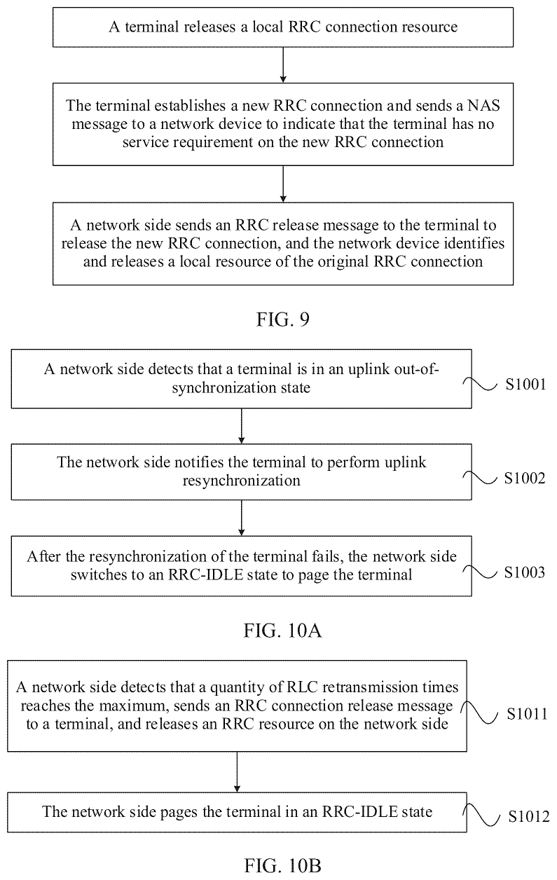

In conclusion, an embodiment of this application provides a method for releasing a radio resource control RRC connection. As shown in FIG. 9, first, a terminal releases a local RRC connection resource, causing inconsistency between RRC statuses maintained by the terminal and a network, and then triggers a corresponding NAS procedure, that is, establishes a new RRC connection and sends a NAS message to a network device to indicate that the terminal has no service requirement on the new RRC connection. Finally, the network device sends an RRC connection release message to the terminal based on the NAS message sent by the terminal and a standard protocol procedure, to release the new RRC connection. In addition, in this process, the network device identifies and releases a local resource of the original RRC connection, to save power.

It should be noted that, in this embodiment of this application, the terminal releases the RRC connection on a single side. In this case, the RRC status maintained by the terminal is inconsistent with the RRC status maintained by the network. If the solution in this embodiment of this application finally does not take effect due to a network reason, the RRC status maintained by the terminal is still inconsistent with the RRC status maintained by the network. In this case, there are two possible procedures in which the network sends data to the terminal. One of the procedures is shown in FIG. 10A, and specifically includes the following steps.

S1001. The network device detects that the terminal is in an uplink out-of-synchronization state. An RRC status maintained by the network device for the terminal is the RRC_CONNECTED state. To maintain uplink synchronization of the terminal, an L2 of a radio access protocol layer of the network device periodically sends a TA MCE (Timing Advance MAC Control Element) to the terminal. Because the terminal has released the RRC resource, the terminal cannot receive the TA MCE and cannot return an ACK (Acknowledgement) corresponding to the TA MCE to the network device. In this case, the network device detects that the terminal is out of synchronization in the uplink.

S1002. The network device notifies the terminal to perform uplink resynchronization. The L2 of the radio access protocol layer of the network device sends a PDCCH Order to the terminal to notify the terminal to perform uplink resynchronization. If the uplink resynchronization succeeds, the terminal re-establishes an RRC connection to restore a service. If the uplink resynchronization fails, Step S1003 is performed.

S1003. After the resynchronization of the terminal fails, the network device switches to the RRC-IDLE state to page the terminal. After receiving a paging message of the network device, the terminal re-establishes an RRC connection to the network device.

As shown in FIG. 10B, the other possible procedure specifically includes the following steps.

S1011. The network device detects that a quantity of RLC retransmission times reaches the maximum, sends an RRC connection release message to the terminal, and releases an RRC resource of the network device, and then the RRC status maintained by the network device is switched to the RRC-IDLE state. Specifically, when the RLC configuration of the terminal is an AM mode (Acknowledgement Mode), data sent by the network device to the terminal needs to be acknowledged at the RLC layer. If no acknowledgment is received, the network device retransmits the data at the RLC layer. When the number of retransmissions at the RLC layer of the network device reaches the maximum, an RRC connection release procedure is triggered.

S1012. The network device pages the terminal in the RRC-IDLE state, and after receiving a paging message of the network device, the terminal establishes an RRC connection to the network device.

It can be learned from the foregoing described procedure that, even if the solution in this embodiment of this application does not take effect due to a network reason, the network device restores normal service transmission for the terminal in a corresponding self-healing manner.

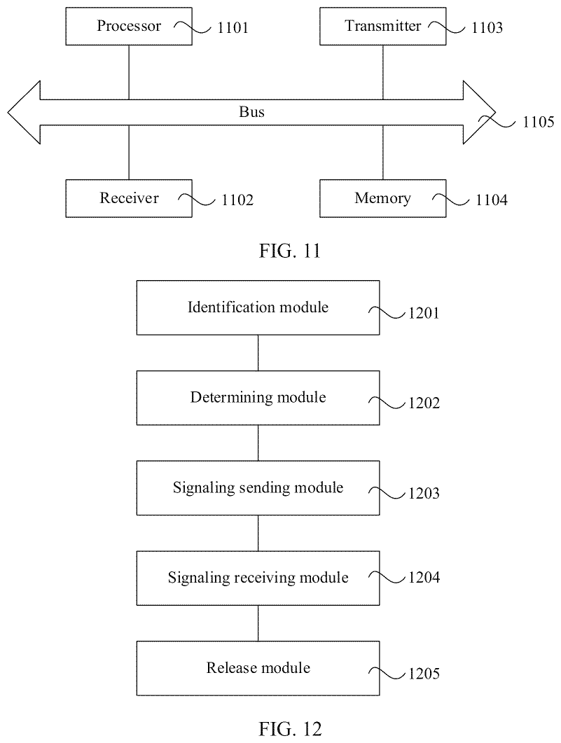

FIG. 11 is a schematic diagram of a structure of a terminal according to an embodiment of this application. The terminal includes a processor 1101, a receiver 1102, a transmitter 1103, a memory 1104, and a bus 1105. The processor 1101 includes one or more processing cores. The processor 1101 runs a software program and a module, to execute various functional applications and perform information processing. The receiver 1102 and the transmitter 1103 may be implemented as a communication component, and the communication component may be a baseband chip. The memory 1104 is connected to the processor 1101 through the bus 1105. The memory 1104 may be configured to store at least one program instruction, and the processor 1101 is configured to execute the at least one program instruction, to implement the technical solutions in the foregoing embodiments. Implementation principles and technical effects thereof are similar to those of the foregoing method embodiments. Details are not described herein again.

In this embodiment of this application, the processor may be a general-purpose processor, a digital signal processor, an application-specific integrated circuit, a field programmable gate array or another programmable logic device, a discrete gate or transistor logic device, or a discrete hardware component, and may implement or perform the methods, steps, and logical block diagrams disclosed in embodiments of this application. The general-purpose processor may be a microprocessor, any conventional processor, or the like. The steps of the method disclosed with reference to embodiments of this application may be directly performed by a hardware processor, or may be performed by using a combination of hardware in the processor and a software module.

In this embodiment of this application, the memory may be a non-volatile memory, for example, a hard disk drive (hard disk drive, HDD) or a solid-state drive (solid-state drive, SSD), or may be a volatile memory (volatile memory), for example, a random access memory (random access memory, RAM). The memory is any other medium that can be configured to carry or store expected program code in a form of an instruction structure or a data structure and that can be accessed by a computer, but is not limited thereto.

The memory in this embodiment of this application may be alternatively a circuit or any other apparatus that can implement a storage function, and is configured to store program instructions and/or data. All or some of the methods provided in embodiments of this application may be implemented by using software, hardware, firmware, or any combination thereof. When software is used to implement the methods, all or some of the methods may be implemented in a form of a computer program product. The computer program product includes one or more computer instructions. When the computer program instructions are loaded and executed on the computer, the procedure or the functions according to embodiments of this application are all or partially generated. The computer may be a general-purpose computer, a special-purpose computer, a computer network, a network device, user equipment, or another programmable apparatus. The computer instruction may be stored in a computer-readable storage medium or may be transmitted from a computer-readable storage medium to another computer-readable storage medium. For example, the computer instruction may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk drive, or a magnetic tape), an optical medium (for example, a digital video disc (digital video disc, DVD)), a semiconductor medium (for example, an SSD), or the like.

An embodiment of this application provides a computer program product. When the computer program product runs on a terminal, the terminal is enabled to perform the technical solutions in the foregoing embodiments. Implementation principles and technical effects thereof are similar to those of the foregoing related embodiments. Details are not described herein again.

An embodiment of this application provides a computer-readable storage medium. The computer-readable storage medium stores program instructions. When the program instructions are executed by a terminal, the terminal is enabled to perform the technical solutions in the foregoing embodiments. Implementation principles and technical effects thereof are similar to those of the foregoing related embodiments. Details are not described herein again.

An embodiment of this application provides an apparatus for releasing a radio resource control RRC connection. The apparatus may be a terminal, or may be a chip. When the apparatus is a chip, the apparatus may be a system-on-a-chip (System-on-a-Chip, SoC) main chip or a baseband modem (modem) chip, and the chip may be applied to the terminal. When the apparatus is a terminal, the apparatus may also be referred to as user equipment (user equipment, UE), an access terminal, a subscriber unit, a subscriber station, a mobile station, a mobile console, a remote station, a remote terminal, a mobile device, a user terminal, a wireless communication device, a user agent, or a user apparatus. The apparatus includes a processor, and the processor is configured to: be coupled to a memory, read instructions in the memory, and execute, according to the instructions, the technical solutions in the foregoing embodiments, for example, the technical solutions in the method embodiments. The memory may be integrated into the processor, or may be independent of the processor. The memory includes a cache (Cache), and may store frequently accessed data/instructions.

FIG. 12 shows an apparatus for releasing an RRC connection according to an embodiment of this application. The apparatus for releasing an RRC connection may implement, by using software, hardware, or a combination of software and hardware, some or all of the technical solutions in the foregoing embodiments, for example, the method embodiments. The apparatus includes an identification unit 1201, a determining unit 1202, a signaling sending unit 1203, and a releasing unit 1204.

The identification unit 1201 is configured to identify a service scenario type of a terminal, where the service scenario type includes a sleep mode, a screen-off mode, a screen-on mode, and the like, and is further configured to identify an application type of service data, for example, an application of a low-delay service type.

The determining unit 1202 is configured to determine whether service data transmission of the terminal ends, which may be implemented in a manner of starting a timer or in a TTI interrupt manner.

The signaling sending unit 1203 is configured to: when it is detected that the terminal does not transmit service data within first duration, send a NAS message to a network device, and indicate the network device to release a radio air interface resource in the NAS message, so as to trigger the network device to release the RRC connection of the terminal.

The signaling receiving unit 1204 is configured to receive an RRC connection release message sent by the network device.

The releasing unit 1205 is configured to release a local RRC connection when it is detected that the terminal does not transmit service data within the first duration. The releasing unit 1205 is further configured to receive an RRC connection release message sent by the network device, to release the RRC connection.

In conclusion, the foregoing embodiments are merely intended for describing the technical solutions of this application instead of limiting this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

1.-36. (canceled)

37. A method implemented by a terminal, wherein the method comprises:
releasing a first local resource of a first Radio Resource Control (RRC) connection, wherein the first RRC connection is for first data transmission between the terminal and a network device;
establishing a second RRC connection to the network device when releasing the first RRC connection; and
sending, to the network device through the second RRC connection, a registration message to register with the network device and to indicate that the terminal does not have any service requirement on the second RRC connection.

38. The method of claim 37, wherein the method further comprising:
receiving, from the network device, a second RRC connection release message that is based on the registration message; and
releasing, in response to the second RRC connection release message, a second local resource of the second RRC connection.

39. The method of claim 37, wherein after releasing the first local resource and before establishing the second RRC connection, the method further comprises generating the registration message.

40. The method of claim 37, further comprising:
determining to release the first RRC connection when detecting that service data is not transmitted within a duration; or
determining, based on machine learning prediction, to release the first RRC connection.

41. The method of claim 40, further comprising setting, based on a service scenario type, the duration.

42. The method of claim 41, wherein the service scenario type comprises at least one of a screen on and a WI-FI not connected, the screen off and the WI-FI not connected, the WI-FI connected, or a sleep mode.

43. The method of claim 40, further comprising setting, based on applications of different service data types, the duration.

44. The method of claim 37, further comprising avoiding receiving, from the network device, a first RRC connection release message when releasing the first RRC connection.

45. The method of claim 37, wherein the registration message is:
a registration request message in a New Radio (NR) standalone networking system; or
a tracking area update request message in a Long-Term Evolution (LTE) system.

46. The method of claim 45, wherein when releasing the first RRC connection, the method further comprises:
performing, by an RRC layer of the terminal, a local RRC resource release;
sending a resource release indication message to a layer one of the terminal and a layer two of the terminal; and
sending a first message to a non-access stratum of the terminal, wherein the first message triggers the non-access stratum to generate the registration message.

47. The method of claim 37, further comprising establishing a third RRC connection of a New Radio (NR) between the terminal and the network device, wherein the first RRC connection is a Long-Term Evolution (LTE) connection in an NR non-standalone networking system and is for second data transmission of the terminal on an LTE side, wherein the third RRC connection is for third data transmission of the terminal on an NR side, wherein the registration message is a tracking area update request message, and wherein the second RRC connection is of the LTE.

48. The method of claim 47, further comprising:
determining that the first RRC connection is to be released and that no RRC connection of NR exists; and
releasing a second local resource of the first RRC connection.

49. The method of claim 48, wherein before determining that the first RRC connection is to be released and that no RRC connection of NR exists, the method further comprises:
sending a first message to the network device when releasing the third RRC connection, wherein the first message instructs the network device to release the third RRC connection;
receiving, from the network device, a second message; and
releasing, in response to the second message, a third local resource of the third RRC connection.

50. The method of claim 48, further comprising:
performing, by an RRC layer on the LTE side, a local RRC resource release;
sending a resource release indication message to a layer 1 on the LTE side and a layer 2 on the LTE side; and
sending a first message to a non-access stratum of the terminal, wherein the first message triggers the non-access stratum to generate the registration message.

51. The method of claim 47, further comprising releasing a second local resource of the first RRC connection and a second local resource of the third RRC connection when releasing the first RRC connection and the third RRC connection.

52. An apparatus comprising:
a memory configured to store instructions; and
a processor coupled to the memory and configured to execute the instructions to cause the apparatus to:
release a first local resource of a first Radio Resource Control (RRC) connection;
establish a second RRC connection to a network device when releasing the first RRC connection; and
send, to the network device through the second RRC connection, a registration message to register with the network device and to indicate that the apparatus does not have any service requirement on the second RRC connection.

53. The apparatus of claim 52, wherein the processor is further configured to execute the instructions to cause the apparatus to:
receive a second RRC connection release message from the network device, wherein the second RRC connection release message is based on the registration message; and
release a second local resource of the second RRC connection in response to the second RRC connection release message.

54. The apparatus of claim 52, wherein after releasing the first local resource and before establishing the second RRC connection, the processor is further configured to execute the instructions to cause the apparatus to generate the registration message.

55. The apparatus of claim 52, wherein the processor is further configured to execute the instructions to cause the apparatus to:
release the first RRC connection when detecting that service data is not transmitted within a duration; or
release the first RRC connection based on machine learning prediction.

56. The apparatus of claim 55, wherein the processor is further configured to execute the instructions to cause the apparatus to set the duration based on a service scenario type.
